(19) United States
(12) Patent Application Publication
(10) Pub. No.: US 2021/0346912 A1
(43) Pub. Date: Nov. 11, 2021

(54) MULTI-LAYER PAINT STRUCTURE WITH IMPROVED LAYER ADHESION

(71) Applicant: Covestro Intellectual Property GmbH & Co. KG, Leverkusen (DE)

(72) Inventors: Florian Golling, Düsseldorf (DE); Andreas Hecking, Langenfeld (DE); Jan Weikard, Leverkusen (DE); Hans-Josef Laas, Odenthal (DE); Tanja Hebestreit, Wipperfürth (DE); Katja Riehl, Leverkusen (DE); Frank Langenfeld, Leichlingen (DE)

(21) Appl. No.: 17/286,503

(22) PCT Filed: Oct. 24, 2019
(86) PCT No.: PCT/EP2019/078964

§ 371 Date: Apr. 19, 2021

(30) Foreign Application Priority Data
Oct. 30, 2018 (EP) 18203254.0

(51) Int. Cl. B05D 7/00; C09D 5/00; C09D 175/04; C09D 133/04

(52) U.S. Cl. CPC B05D 7/546; B05D 7/536; C09D 133/04; C09D 175/04; C09D 5/002

(57) ABSTRACT

The present invention relates to a layer composite comprising a lower base paint layer and a cover layer arranged thereabove on a substrate, wherein the base paint is greater than or equal to 50 wt. % and less than 100 wt. % of polymers selected from the group consisting of polyacrylates, polyurethanes, polyether polyols, polycarbonate polyols, polyester polyols, melamine resins, alkyd resins or mixtures thereof; the cover layer is greater than or equal to 40 wt. % and less than or equal to 100 wt. % of prepolymers containing silane groups and/or the crosslinking products thereof; and the base paint is greater than or equal to 0.5 wt. % and less than or equal to 15 wt. % of prepolymers containing silane groups and/or the crosslinking products thereof, and wherein the prepolymers containing silane groups and/or the crosslinking products thereof have at least one thiourethane and/or urethane unit in the molecule. The invention further relates to a method for producing a claimed layer composite and to a vehicle or a vehicle body part having such a layer composite.

The present invention relates to a composite coating composed of a lower basecoat and over it a topcoat on a substrate. The invention further relates to a method for producing a composite coating of the invention, and also to a bodywork part having just such a composite coating.

The functionalizing of surfaces by application of further coats to workpieces is an important method utilized in numerous sectors of industry. As well as purely esthetic qualities, this additional step can also be used to modify important service properties of the workpieces, allowing utility-appropriate adaptations to be achieved with one and the same basic structure. This flexibility becomes all the more important in the sector of the consumer goods industry, which in order to diversify the product portfolio expects a certain degree of individualizability based on standard components. For high-value goods, such as automobiles, then, it is typically the case that the external appearance can be individualized on the basis of a (freely) chooseable paint color. This paint finish is made generally in a plurality of coats, since just one coat as such is unable to feature the entirety of properties required. Accordingly, with multicoat automobile paint systems, a primer is first applied, which depending on substrate is intended to improve the adhesion between the substrate and the following coat or coats.

This coating base may further serve to protect the substrate from corrosion, if it is susceptible to corrosion. In addition, the primer ensures an improvement in the surface characteristics, by covering over any roughness and structure present in the substrate. Especially in the case of metal and plastic substrates, a surfacer is often applied to the primer, the task for said surfacer being to further improve the surface characteristics and to bring improvement to the susceptibility to stonechipping. Applied to the surfacer, usually, are one or more coloring and/or effect coats, which are referred to as the basecoat. Lastly, a highly crosslinked topcoat is generally applied to the basecoat, and ensures the desired glossy appearance and protects the paint system from environmental effects.

Where primarily clear topcoats are to be obtained, it is possible, for example, to use silane-functional prepolymers, especially silane-functional polyurethane prepolymers, to construct topcoats. Polyurethanes bearing silane groups may be produced in a variety of ways, as for example by reaction of polyisocyanates or isocyanate-functional prepolymers with silane compounds that are reactive toward isocyanate groups, such as, for example, secondary aminoalkylsilanes or mercaptoalkylsilanes

The synthesis of specifically partially silanized, alkoxysilane-functionalized polyols of high molecular weight, and of alkoxysilanes of low molecular weight, is described in the literature. One option is to react hydroxy-functionalized compounds, such as polyether, polyurethane or polyester polyols, with isocyanatoorganosilanes, such as, for example, the isocyanatoalkoxysilanes described in U.S. Pat. No. 3,494,951 or EP-A 0 649 850. Another option is the reaction of isocyanatopropyltrimethoxysilane or isocyanatopropyltriethoxysilane with polyols as disclosed in WO 2009/115079.

Adducts of isocyanatoalkylalkoxysilanes, such as isocyanatopropyltrimethoxysilane, and low molecular weight, branched diols or polyols, containing up to 20 carbon atoms, are subjects of EP-A 2 641 925. In addition to the low molecular weight branched diols or polyols it is also possible in the preparation of the adducts to use as well, in a fraction of up to 40 wt. %, further diols and/or polyols, including, for example, hydroxyl-containing polyesters or polyacrylates. Thus, for example, WO 2013/189882 describes adducts of isocyanatotrialkoxysilanes and polyhydric alcohols as additional crosslinking agents in nonaqueous, two component polyurethane coating materials (2K-PU).

WO 2014/180623 describes moisture-curable coating compositions containing at least one adduct of an isocyanatosilane on a hydroxy-functional compound, a tin-containing catalyst and an aminosilane. Recited as suitable hydroxy-functional compounds for preparing the adducts are monohydric or polyhydric alcohols and also polyols, including—in a long listing of suitable polymeric polyols—hydroxy-functional polyacrylates.

WO 2008/034409 describes by way of example the partial reaction of a commercial polyester polyol Desmophen 1145 (Covestro Deutschland AG) with a substoichiometric amount of isocyanatopropyltriethoxysilane. On account of the equivalents ratio chosen, less than 15% of the hydroxyl groups originally present in the polyol are urethanized in this case.

Additionally, WO 2014/037265 discloses the preparation of silane-functional binders having a thiourethane structure by reaction of polyols with diisocyanate/mercaptosilane adducts of low monomer content.

The prior art discloses copiously silane-functional polymers as an additional crosslinking component in paint systems. These coats utilize “customary” paint-system polymers, and modify their properties via the addition of this further component. The construction of paint coats essentially solely on the basis of silane-functional polymers, by contrast, is much less frequently encountered. This is due partly to the fact that topcoats with silane-functional polymers as main components exhibit significantly more complex drying properties on the various basecoat films than do the coating materials typically used. The coating properties are much more variable and, moreover, the drying kinetics are significantly poorer than those of the known coating materials. Moreover, the adhesion of silane group-containing prepolymer coats on basecoat materials may be hindered, resulting only in an inadequately adhering system, and the possible manifestations of this may include a poorer weathering resistance.

For these reasons, there exists in the art, still, a demand for suitable combinations of basecoat and silane-functional topcoat materials, where the composite coating is to have functional properties, especially adhesion properties and weathering properties, that are comparable with those of known paint coatings.

It is therefore the object of the present invention to provide a composite coating having good mechanical properties, particularly a good adhesion and good solvent resistance and weathering resistance. It is the object of the present invention, furthermore, to provide a method for producing these functional composite coatings with silane-functional topcoats.

The object is achieved in accordance with the invention by the features of claim 1 for the composite coating, and by the features of claim 9 for a method of the invention. Advantageous developments are specified in the dependent claims. They may be combined freely, unless the context clearly dictates otherwise. In the invention, the references to “comprising”, “containing”, etc., preferably denote “substantially consisting of” and very preferably denote “consisting of”.

In accordance with the invention, therefore, is a composite coating composed of a lower basecoat and over it a topcoat on a substrate, characterized in that the basecoat material comprises greater than or equal to 50 wt. % and less than 100 wt. % of polymers selected from the group consisting of polyacrylates, polyurethanes, polyether polyols, polycarbonate polyols, polyester polyols, melamine resins, alkyd resins, or mixtures thereof; the topcoat comprises greater than or equal to 40 wt. % and less than or equal to 100 wt. % of silane group-containing prepolymers and/or crosslinking products thereof; and the basecoat material comprises greater than or equal to 0.5 wt. % and less than or equal to 15 wt. % of silane group-containing prepolymers and/or crosslinking products thereof; and where the silane group-containing prepolymers and/or crosslinking products thereof have at least one thiourethane unit and/or urethane unit in the molecule.

Surprising it has been found that for a composite coating composed of a basecoat material and a topcoat material comprising silane group-containing prepolymers, it is possible to obtain extraordinary strength of adhesion of the two coats, and therefore improved mechanical properties on the part of the composite coating. These improved mechanical properties are obtained for a series of different basecoats, and, without being tied to the theory, the reason for the improved adhesion may be that a part of the silane group-containing prepolymers applied as topcoat is capable of diffusing into the defined basecoats. Consequently there may be improved adhesion between the two coats, associated with an improvement in the mechanical properties. Furthermore, the amount of the diffusing, silane group-containing prepolymers also appears to affect the mechanical properties, and so the improved mechanical properties would not be obtainable by simply admixing the silane group-containing prepolymers to a basecoat material. Without being tied to the theory, the combination of the two defined coats and the controlled diffusion of the topcoat component appear to contribute to the improved properties of the composite. It is advantageous, moreover, that the topcoat which can be used in the invention has no substantial effect on the visual properties of the composite, allowing the color and other optical effects to be determined to a high degree via the properties of the basecoat. It is possible accordingly to do without costly and inconvenient tests for changes to the color of the composite as a function of the applied topcoat.

The invention provides a composite coating composed of a lower basecoat and over it a topcoat. The at least two-coat system of the invention may be used as the sole system for modifying a substrate, or in combination with other coats. For example, it is possible, starting from the substrate, for there to be further coats as well as the basecoat. The further coats are in that case situated beneath the basecoat. A feature of the coat system of the invention, therefore, is a physical contact between the basecoat of the invention and the topcoat of the invention. Above the topcoat, moreover, there may also be further coats, which can be applied, independently of the topcoat of the invention, after the latter has cured. Also within the invention, therefore, is a sandwich made from the composite of the invention, having the combination of both coats inside. This means that from the substrate side to the air side, the basecoat is situated closer to the substrate and the topcoat is situated closer to the air.

The upper topcoat may be a clearcoat, meaning that the topcoat is transparent and the visual properties of the composite coating are determined via the visual properties of the basecoat.

Transparency of a pigmented or unpigmented system refers to the property of that system of scattering light to an extremely small extent. Accordingly, in the case of application to a black background, the change to the color of the black background is to be extremely small. The smaller the color difference relative to the black background, the greater the transparency of the pigmented or unpigmented system. The transparency of a topcoat is determined on the basis of DIN 55988:2013-04.

The composite coating is disposed on a substrate. Suitable substrates are known to the skilled person. Hence the composite coating may be applied to solid subsurfaces such as glass or metal. It is, however, also possible for the substrates used to be polymeric carrier materials, examples being circuit boards. Examples of suitable metal surfaces are iron, steel, aluminum, or the like. For coating, the substrates may be uncoated or may have been coated. It is possible that primers and/or surfacers, for example, have already been applied to the substrate as coating before it is used in the method of the invention. Examples of primers are especially cathodic dip coats as used in OEM automobile finishing, solventborne or aqueous primers for plastics, especially for plastics having low surface tension, such as PP or PP-EPDM.

The substrates to be provided may comprise a bodywork or parts thereof, comprising one or more of the aforementioned materials. The bodywork or parts thereof preferably comprise(s) one or more materials selected from metal, plastic, or mixtures thereof.

The substrate may comprise metal, and more particularly the substrate may consist of metal to an extent of 80 wt. %, 70 wt. %, 60 wt. %, 50 wt. %, 25 wt. %, 10 wt. %, 5 wt. %, 1 wt. %.

The substrate may consist at least partly of a composite material, more particularly of a composite material comprising metal and/or plastic.

The basecoat comprises greater than or equal to 50 wt. % and less than 100 wt. %, preferably greater than or equal to 40 wt. % and less than or equal to 99.5 wt. %, of polymers selected from the group consisting of polyacrylates, polyurethanes, polyether polyols, polycarbonate polyols, polyester polyols, melamine resins, alkyd resins, or mixtures thereof. This group of basecoat polymers specifically is able to permit sufficient diffusion of the silane group-containing polymers out of the topcoat. In this way, a stronger bond can be formed between the two coats, leading to the improved mechanical properties of the composite. The weight % figure here is based on the dried and cured basecoat material. The basecoat material may comprise the group of above-recited polymers, furthermore, preferably at greater than or equal to 60 wt. % and less than 100 wt. %, preferably at greater than or equal to 60 wt. % and less than or equal to 99.5 wt. %, and further preferably at greater than or equal to 75 wt. % and less than 100 wt. %, preferably at greater than or equal to 75 wt. % and less than or equal to 99.5 wt. %. Within these ranges, the preferred mechanical properties can be obtained. The rest of the basecoat material may be formed by further adjuvants known to the skilled person, such as color pigments. In accordance with the invention, the fractions of the basecoat material and the further constituents having entered by inward diffusion through the topcoat add up to 100 wt. %.

The basecoat material may be a one-component (1K) system or a two-component (2K) or multicomponent (3K, 4K) system.

A one-component (1K) system is a thermally curing coating material wherein the binder and the crosslinking agent are present alongside one another, i.e., in one component.

The term may also refer to a coating material in which, in particular, the binder and the crosslinking agent are present separately from one another, in at least two components which are combined not until shortly before application. This form is chosen when binder and crosslinking agent react with one another even at room temperature. Coating materials of this kind are used in particular for the coating of thermally sensitive substrates, particularly in automotive refinish.

The first constituent of the coating material of the basecoat may be at least one, especially one, ionically and/or nonionically stabilized polyurethane (A) which is saturated, unsaturated and/or grafted with olefinically unsaturated compounds, and which preferably is based on aliphatic, cycloaliphatic, aliphatic-cycloaliphatic, aromatic, araliphatic, aliphatic-aromatic and/or cycloaliphatic-aromatic polyisocyanates. For the stabilization the polyurethane (A) may comprise either

(a1) functional groups which can be converted into cations by neutralizing agents and/or quaternization agents, and/or cationic groups, or

(a2) functional groups which can be converted into anions by neutralizing agents, and/or anionic groups, and/or

(a3) nonionic hydrophilic groups.

They are present in the coating material in the customary and known amounts.

Where the coating material is curable physically, thermally with self-crosslinking, or thermally with self-crosslinking and with actinic radiation, the amount therein of polyurethanes (A) is preferably 50 to 100 wt. %, more preferably 50 to 90 wt. %, and more particularly 50 to 80 wt. %, based in each case on the film-forming solids content of the coating material.

If the coating material is curable thermally with external crosslinking, or thermally with external crosslinking and with actinic radiation, the amount therein of polyurethanes (A) is preferably 10 to 80, more preferably 15 to 75, and more particularly 20 to 70 wt. %, based in each case on the film-forming solids content of the coating material.

The film-forming solids content refers to the sum total of all constituents of the coating material that make up the solid body of the thermoplastic or thermoset materials produced therefrom, preferably of the thermoplastic or thermoset coatings, adhesive layers, seals, films, and moldings, more particularly of the thermoset coatings.

The second constituent of the coating material may be a wetting or dispersing agent (B), which is selected from the group consisting of hyperbranched polymers, polyether-modified polydimethylsiloxanes, ionic and nonionic (meth)acrylate copolymers, high molecular weight block copolymers having groups with pigment affinity, and dialkylsulfosuccinates. Used more particularly are hyperbranched polymers.

The wetting or dispersing agents (B) are materials available commercially, being known per se, and are sold, for example, by BASF under the brand names Starfactant 20 and Hydropalat 875, by Byk Chemie under the brand name Disperbyk 162, 163 and 182 and Byk 348, 355, 381 and 390, by

Coatex under the brand names Coatex P90 and BP3, and by Efka under the brand name Efka 4580. Used more particularly is Starfactant 20.

The wetting or dispersing agents (B) are used in the customary and known, effective amounts. Preferably they are used in an amount of 0.01 to 5, more preferably 0.05 to 2.5, and more particularly 0.1 to 1.5 wt. %, based in each case on the coating material.

The third constituent of the coating material may be at least one organic solvent (C). Suitable solvents are described for example in German patent application DE 102 005 060 A1, page 5 to page 6, paragraphs [0038] to [0040]. The solvent may preferably be triethylene glycol.

The amount of the organic solvent (C) may vary widely and so be tailored optimally to the requirements of the case in hand. In light of the aqueous nature of the coating material, however, the concern will be to minimize the amount of organic solvent (C) therein. A particular advantage in this context is that an organic solvent (C) content of 0.1 to 10, preferably 0.5 to 7, and more particularly 0.5 to 5 wt. % in the coating material, based in each case on the coating material, is sufficient to achieve an advantageous technical effect.

Furthermore, the coating material may further comprise an adjuvant (D). Preferably it comprises at least two adjuvants (D). The adjuvant (D) is preferably selected from the group of the adjuvants typically used in the field of coating materials. The adjuvant (D) is more preferably selected from the group consisting of salts which can be decomposed thermally without residue or substantially without residue; binders different from the polyurethanes (A) and curable physically, thermally and/or with actinic radiation; crosslinking agents; organic solvents other than the organic solvents (C); thermally curable reactive diluents; reactive diluents curable with actinic radiation; color and/or effect pigments; transparent pigments; fillers; molecularly dispersedly soluble dyes; nanoparticles; light stabilizers; antioxidants; air removers; emulsifiers; slip additives; polymerization inhibitors; radical polymerization initiators, thermolabile radical initiators; adhesion promoters; flow control agents; film-forming assistants, such as thickeners and pseudoplastic sag control agents (SCA); flame retardants; corrosion inhibitors; free-flow aids; waxes; siccatives; biocides; and dulling agents.

Suitable adjuvants (D) of the aforementioned kind are known for example from German patent application DE 199 48 004 A1, page 14, line 4 to page 17, line 5, from German patent application DE 199 14 98 A1, column 11, line 9 to column 15 line 63, or from German patent DE 100 43 405 C1, column 5 paragraphs [0031] to [0033]. They are used in the customary and known, effective amounts.

The solids content of the coating material may vary very widely and may therefore be tailored optimally to the requirements of the case in hand. First and foremost, the solids content is guided by the viscosity required for application, more particularly spray application, and so may be adjusted by the skilled person on the basis of their general knowledge, with the assistance where appropriate of a few range finding tests. The solids content is preferably 5 to 70, more preferably 10 to 65, and more particularly 15 to 60 wt. %, based in each case on the coating material.

The coating material is produced preferably with the aid of a coating method. In this method, the above-described constituents (A), (B) and (C), and optionally (D), are dispersed in an aqueous medium, more particularly in water, and then the resulting mixture is homogenized. In terms of technique, the method has no peculiarities technique-wise, but may instead be carried out using the customary and known mixing methods and mixing assemblies, such as stirred tanks, dissolvers, stirred mills, compounders, static mixers, extruders, or in a continuous process.

On account of the advantages of the coating material, and of the coating material produced by means of the method, there are numerous end uses that can be fulfilled. They are preferably used for producing thermoplastic and thermoset, especially thermoset, materials. They are used more preferably as coating materials for producing thermoplastic and thermoset, more particularly thermoset, coatings, which may be joined with firm adhesion or redetachably to primed and unprimed substrates of all kinds.

Examples of suitable substrates are known from German patent application DE 199 48 004 Al, page 17, lines 12 to 36, or from German patent DE 100 43 405 C1, column 2, paragraph [0008], to column 3, paragraph [0017].

Very preferably the coating materials are used as topcoat materials for producing topcoat systems, or as waterborne basecoat materials for producing multicoat color and/or effect paint systems.

Especially preferably they are used as waterborne basecoat materials for producing color and/or effect basecoat systems of multicoat paint systems, preferably multicoat paint systems for automobile bodies.

With these basecoat materials it is possible, very preferably, to produce multicoat paint systems by wet-on-wet methods, in which at least one waterborne basecoat material is applied to a primed or unprimed substrate, resulting in at least one waterborne basecoat film.

On account of the performance properties of the coating material, the thermoplastic and thermoset materials produced therefrom likewise have an outstandingly balanced physiochemical, optical, and mechanical properties profile. Consequently, the films and moldings, and also the substrates coated with the coatings, also have a particularly high utility and a long service life.

Further basecoat films may be basecoat films for low baking temperatures.

One illustrative embodiment includes a curable coating composition for a basecoat with a low baking temperature: a crosslinkable component, comprising an acid-functional acrylic copolymer, polymerized from a monomer mixture comprising 2 percent to 12 percent of monomers containing one or more carboxylic acid groups, where the percentages are based on the total weight of the acid-functional acrylic copolymer; a crosslinking component; and a control agent for a low baking temperature, comprising a rheological component selected from an amorphous silica gel, a clay, or a combination thereof, where the rheological component is present in an amount of about 0.1 to about 10 wt. %, and about 0.1 wt. % to about 10 wt. % of polyurea, with the percentages being based on the total weight of the crosslinkable and crosslinking components.

In one illustrative embodiment, the multicoat coating system includes: a curable basecoat coating for a low baking temperature, comprising: a crosslinkable component, comprising an acid-functional acrylic copolymer, polymerized from a monomer mixture comprising 2 wt. % to 12 wt. % of monomers containing one or more carboxylic acid groups, where the percentages are based on the total weight of the acid-functional acrylic copolymer; a crosslinking component; and a control agent for a low baking temperature, comprising a rheological component selected from an amorphous silica gel, a clay, or a combination thereof, where the rheological component is present in an amount of 0.1 to about 10 wt. %, and about 0.1 wt. % to about 10 wt. % of polyurea, where the percentages are based on the total weight of the crosslinkable and crosslinking components.

In coating applications, especially automotive repair or OEM applications, a critical factor is the productivity, i.e., the capacity of a coat of a coating composition to dry rapidly to a “strike-in”—resistant or mixing-resistant state, so that a subsequent coating film, such as a film formed from a clear coating composition, does not adversely affect the underlying film. When the topmost coat has been applied, the multilayer system ought then to cure sufficiently rapidly without adverse influence on the uniformity of color and appearance. The present invention addresses the aspects above by utilizing a unique crosslinking technology and an additive. The present coating composition, accordingly, includes a crosslinkable and a crosslinking component.

The crosslinkable component includes about 2 wt. % to about 25 wt. %, preferably about 3 wt. % to about 20 wt. %, more preferably about 5 wt. % to about 15 wt. % of one or more acid-functional acrylic copolymers, with all of the percentages being based on the total weight of the crosslinkable component. If the composition contains more than the upper limit of the acid-functional acrylic copolymer, the resulting composition generally has more than the required application viscosity. If the composition contains less than the lower limit of the acid-functional copolymer, the resulting coating would have insubstantial strike-in (or mixing) properties for a multicoat system or control of flake and/or platelet orientation in general.

The crosslinkable component comprises an acid-functional acrylic copolymer, polymerized from a monomer mixture which comprises about 2 wt. % to about 12 wt. %, preferably about 3 wt. % to 10 wt. %, more preferably about 4 wt. % to about 6 wt. % of monomers containing one or more carboxylic acid groups, with all of the percentages being based on the total weight of the acid-functional acrylic copolymer. If the amount of the carboxylic acid group-containing monomer in the monomer mixture exceeds the upper limit, the coatings resulting from such a coating composition would have unacceptable sensitivity to water, and, if the amount is less than the lower limit, the coating obtained would have insubstantial “strike-in” properties for a multilayer system or flake orientation control in general.

The acid-functional acrylic copolymer preferably has a weight-average molecular weight by GPC (in g/mol), determined in accordance with DIN 55672:2016-03, in the range from about 8000 to about 100 000, preferably from about 10 000 to about 50 000, and more preferably from about 12 000 to about 30 000. The copolymer preferably has a polydispersity in the range from about 1.05 to about 10.0, preferably in a range from about 1.2 to about 8, and more preferably in a range form about 1.5 to about 5. The copolymer preferably has a T_{g} in the range from about -5° C. to about +100° C., preferably of about 0° C. to about 80° C., and more preferably of about 10° C. to about 60° C.

The monomers containing carboxylic acid group(s) that are suitable for use in the present invention include (meth)acrylic acid, crotonic acid, oleic acid, cinnamic acid, glutaconic acid, muconic acid, undecyleneic acid, itaconic acid, crotonic acid, fumaric acid, maleic acid, or a combination thereof (Meth)acrylic acid is preferred. It is understandable that users also consider the provision of the acid-functional acrylic copolymer with carboxylic acid groups through the generation of a copolymer polymerized from a monomer mixture which comprises anhydrides of the aforesaid carboxylic acids, and then hydrolysis of such copolymers in order to provide the resulting copolymer having carboxylic acid groups. Maleic and itaconic anhydrides are preferred. The users may further consider the hydrolysis of such anhydrides in their monomer mixture before the polymerization of the monomer mixture to give the acid-functional acrylic copolymer.

It may be assumed that the presence of carboxylic acid groups in the copolymer of the present invention appears to raise the viscosity of the resulting coating composition on the basis of the physical network, which was formed through the well-known hydrogen bonds of carboxyl groups. The outcome is that such raised viscosity supports “strike-in” properties in multicoat systems and flake orientation control in general.

The monomer mixture suitable for use in the present invention includes about 5 percent to about 40 percent, preferably about 10 percent to about 30 percent, of one or more functional (meth)acrylate monomers, with all being based on the total weight of the acid-functional acrylic copolymer. It should be noted that if the amount of the functional (meth)acrylate monomers in the monomer mixture exceeds the upper limit, the pot life of the resulting coating composition is reduced, and if less than the lower limit is used, it adversely affects the resulting coating properties, such as shelflife. The functional (meth)acrylate monomer may be provided with one or more crosslinkable groups, selected from a primary hydroxyl, secondary hydroxyl, or a combination thereof.

Some (meth)acrylate monomers containing suitable hydroxyl may have the following structure:

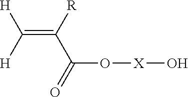

in which R is H or methyl and X is a divalent unit which may be substituted or unsubstituted C₁ to C₁₈ linear aliphatic unit or substituted or unsubstituted C₃ to C₁₈ branched or cyclic aliphatic unit. Some of the suitable substituents include nitrile, amide, halide, such as chloride, bromide, fluoride, acetyl, acetoacetyl, hydroxyl, benzyl, and aryl. Some specific hydroxyl-containing (meth)acrylate monomers in the monomer mixture include 2-hydroxyethyl (meth)acrylate, 2-hydroxypropyl (meth)acrylate, 3-hydroxypropyl (meth)acrylate, and 4-hydroxybutyl (meth)acrylate.

The monomer mixture may also include one or more nonfunctional (meth)acrylate monomers. If used here, nonfunctional groups are those which do not crosslink with a crosslinking component. Some suitable nonfunctional C₁ to C₂₀ alkyl (meth)acrylates include methyl (meth)acrylate, ethyl (meth)acrylate, propyl (meth)acrylate, butyl (meth)acrylate, pentyl (meth)acrylate, hexyl (meth)acrylate, octyl (meth)acrylate, nonyl (meth)acrylate, isodecyl (meth)acrylate, and lauryl (meth)acrylate; branched alkyl monomers, such as isobutyl (meth)acrylate, t-butyl (meth)acrylate, and 2-ethylhexyl (meth)acrylate; and cyclic alkyl monomers, such as cyclohexyl (meth)acrylate, methylcyclohexyl (meth)acrylate, trimethylcyclohexyl (meth)acrylate, tert-butylcyclohexyl (meth)acrylate, and isobornyl (meth)acrylate. Isobornyl (meth)acrylate and butyl acrylate are preferred.

The monomer mixture may likewise include one or more other monomers for the purpose of achieving the desired properties, such as hardness, appearance, and resistance to damage. Some other such monomers include, for example, styrene, a-methylstryene, acrylonitrile and methacrylonitrile. If present, the monomer mixture preferably includes such monomers in the range from about 5 percent to about 30 percent, with all percentages being present in wt. %, based on the total weight of the polymer solids. Styrene is preferred.

Any conventional bulk or solution polymerization method may be used in order to prepare the acid-functional acrylic copolymer of the present invention. One of the suitable methods for preparing the copolymer of the present invention includes a free radical solution polymerization of the monomer mixture described above.

The monomer mixture may be polymerized by addition of conventional thermal initiators, such as azos, illustrated for example by Vazo 64, obtained from DuPont Company, Wilmington, Delaware; and peroxides, such as t-butyl peroxyacetate. The molecular weight of the copolymer obtained may be controlled by adjusting the reaction temperature, the selection and the amount of the initiator used, as performed by the skilled person.

The crosslinking component of the present invention may include one or more polyisocyanates, melamines, or a combination thereof. Polyisocyanates are preferred.

Typically the polyisocyanate is provided in the range from about 2 to about 10, preferably about 2.5 to about 8, more preferably of about 3 to about 5 isocyanate functionalities. In general the ratio of equivalents of isocyanate functionalities on the polyisocyanate per equivalent of all of the functional groups which are present in the crosslinking components is situated in ranges from about 0.5/1 to about 3.0/1, preferably from about 0.7/1 to about 1.8/1, more preferably from about 0.8/1 to about 1.3/1. Some suitable polyisocyanates include aromatic, aliphatic or cycloaliphatic polyisocyanates, trifunctional polyisocyanates, and isocyanate-functional adducts of a polyol and difunctional isocyanates, Some of the particular polyisocyanates include diisocyanates, such as 1,6-hexamethylene diisocyanate, 1,5-pentamethylene diisocyanate, isophorone diisocyanate, 4,4′-biphenylene diisocyanate, toluene diisocyanate, 4,4-methylenedicyclohexyl diisocyanate, biscyclohexyl diisocyanate, xylylene diisocyanate, tetramethylenexylene diisocyanate, 1,4-H6-xylylene diisocyanate, ethylethylene diisocyanate, 1-methyltrimethylene diisocyanate, 1,3-phenylene diisocyanate, 1,5-napthalene diisocyanate, bis(4-isocyanatocyclohexyl)methane, and 4,4′-diisocyanatodiphenyl ether.

Some suitable trifunctional polyisocyanates include triphenylmethane triisocyanate, 1,3,5-benzene triisocyanate, and 2,4,6-toluene triisocyanate. Trimers of diisocyanate, such as the trimer of hexamethylene diisocyanate, sold under the tradename Desmodur N-3390 by Covestro AG, Leverkusen, North Rhein-Westfalen, and the trimer of isophorone diisocyanate, are also suitable.

Also suitable, furthermore, are trifunctional adducts of triols and diisocyanates. Trimers of diisocyanates and also trimers of isophorone, pentamethylene, and hexamethylene diisocyanates are preferred.

Typically the coating composition may include about 0.1 wt. % to about 40 wt. %, preferably about 15 wt. % to about 35 wt. %, and more preferably about 20 wt. % to about 30 wt. % of the melamine, with the percentages being based on the total weight of composition solids.

Some suitable melamines include monomeric melamine, polymeric melamine-formaldehyde resin, or a combination thereof. The monomeric melamines include melamines with a low molecular weight which comprise on average three or more methylol groups, etherified with a monohydric C₁ to C₅-alcohol, such as methanol, n-butanol or isobutanol, per triazine ring, and which have a mean degree of condensation of up to about 2 and preferably in the range from about 1.1 to about 1.8, and have a fraction of monocyclic species of not less than about 50 wt. %. In contrast to this, the polymeric melamines have a mean degree of condensation of more than about 1.9. Some such suitable monomeric melamines include alkylated melamines, such as methylated, butylated, isobutylated melamines, and mixtures thereof. Many of these suitable monomeric melamines are supplied commercially. For example, Cytec Industries Inc., West Patterson, New Jersey, supply Cymel 301 (degree of polymerization of 1.5, 95% methyl and 5% methylol), Cymel 350 (degree of polymerization of 1.6, 84% methyl and 16% methyol) 303, 325, 327, 370 and W3106, which are all monomeric melamines Suitable polymeric melamines include melamine with a high amino fraction (partly alkylated, —N, —H), known in the form of Resimene BMP5503 (molecular weight 690, polydispersity of 1.98, 56% butyl, 44% amino), which is obtained from Solutia Inc., St. Louis, Miss., or Cyme11158, provided by Cytec Industries Inc., West Patterson, New Jersey. Cytec Industries Inc. also supply Cymel 1130 with 80 percent solids (degree of polymerization of 2.5), Cymel 1133 (48% methyl, 4% methylol and 48% butyl), both of them being polymeric melamines

If desired, suitable catalysts which are present in the crosslinkable component may accelerate the curing procedure of a pot mix or batch mix of the coating composition.

If the crosslinking component includes polyisocyanate, the crosslinkable component of the coating composition preferably includes a catalytically active amount of one or more catalysts for accelerating the curing procedure. In general there is a catalytically active amount of the catalysts in the coating composition, in ranges from about 0.001 percent to about 5 percent, preferably ranges from about 0.005 percent to about 2 percent, more preferably ranges from about 0.01 percent to about 1 percent, with all in wt. %, based on the total weight of crosslinkable and crosslinking component solids. A wide multiplicity of catalysts may be used, such as tin compounds, including dibutyltin dilaurate and dibutyltin diacetate; tertiary amines, such as triethylenediamine These catalysts may be used individually or in conjunction with carboxylic acids, such as acetic acid or benzoic acid. Particular suitability is possessed by a commercially available catalyst sold under the brand name Fastcat 4202, i.e., dibutyltin dilaurate, from Arkema North America, Inc., Philadelphia, Penn.

Where the crosslinking component comprises melamine, it likewise preferably includes a catalytically active amount of one or more acidic catalysts to further increase the crosslinking of the components on curing. In general the catalytically active amount of the acidic catalyst in the coating composition is in ranges from about 0.1 percent to about 5 percent, preferably in ranges from about 0.1 percent to about 2 percent, more preferably in ranges from about 0.5 percent to about 1.2 percent, with all in wt. %, based on the total weight of crosslinkable and crosslinking component solids. Some suitable acidic catalysts comprise aromatic sulfonic acids, such as dodecylbenzenesulfonic acid, para-toluenesulfonic acid and dinonylnaphthalenesulfonic acid, all of which either are unblocked or are blocked with an amine, such as dimethyloxazolidine and 2-amino-2-methyl-1-propanol, N,N-dimethylethanolamine, or a combination thereof. Other acidic catalysts which may be used are strong acids, such as phosphoric acids, especially phenyl acid phosphate, which may be unblocked or blocked with an amine.

The crosslinkable component of the coating composition may further include in the range from about 0.1 percent to about 95 percent, preferably in the range from about 10 percent to about 90 percent, more preferably in the range from about 20 percent to about 80 percent, and very preferably in the range from about 30 percent to about 70 percent, of an acrylic polymer, a polyester, or a combination thereof, with all being based on the total weight of the crosslinkable component.

The acrylic polymer suitable for use in the present invention may have a weight-average molecular weight (in g/mol) by GPC that exceeds 2000, preferably in the range from about 3000 to about 20 000 and more preferably in the range from about 4000 to about 10 000. The T_{g} of the acrylic polymer varies in the range from 0° C. to about 100° C., preferably in the range from about 10° C. to about 80° C.

The acrylic polymer suitable for use in the present invention may be polymerized conventionally from typical monomers, such as alkyl (meth)acrylates having alkyl carbon atoms in the range from 1 to 18, preferably in the range from 1 to 12, and styrene and functional monomers, such as hydroxyethyl acrylate and hydroxyethyl methacrylate.

The polyester suitable for use in the present invention may have a weight-average molecular weight by GPC that exceeds 1500, preferably in the range from about 1500 to about 100 000, more preferably in the range from about 2000 to about 50 000, even more preferably in the range from about 2000 to about 8000, and very preferably in the range from about 2000 to about 5000. The T_{g} of the polyester varies in the range from about −50° C. to about +100° C., preferably in the range from about −20° C. to about +50° C.

The polyester suitable for use may be polymerized customarily from suitable polyacids, including cycloaliphatic polycarboxylic acids and suitable polyols, which include polyhydric alcohols. Examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic and cyclobutanetetracarboxylic acid. The cycloaliphatic polycarboxylic acids can be used not only in their cis form but also in their trans form and as a mixture of both forms. Examples of suitable polycarboxylic acids which, if desired, can be used together with the cycloaliphatic polycarboxylic acids are aromatic and aliphatic polycarboxylic acids, as for example phthalic acid, isophthalic acid, terephthalic acid, halophthalic acids, such as tetrachlor- or tetrabromophthalic acid, adipic acid, glutaric acid, azelaic acid, sebacic acid, fumaric acid, maleic acid, trimellitic acid and pyromellitic acid.

Suitable polyhydric alcohols include ethylene glycol, propanediols, butanediols, hexanediols, neopentyl glycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol, tris(hydroxyethyl) isocyanate, polyethylene glycol and polypropylene glycol. If desired, monohydric alcohols may also be included, such as, for example, butanol, octanol, lauryl alcohol, ethoxylated or propoxylated phenols, together with polyhydric alcohols.

The crosslinkable component may further include one or more reactive oligomers, such as non-alicyclic (linear or aromatic) oligomers, disclosed in U.S. Pat. No. 6,221,494 B4, page 3, column 4, line 1 to line 48, which are included herein by this reference. Such non-alicyclic oligomers may be prepared using non-alicyclic anhydrides, such as succinic or phthalic anhydrides, or mixtures thereof.

Caprolactone oligomers, which are described in U.S. Pat. No. 5,286,782, page 3, column 4, line 43 to column 5, line 57, which are incorporated herein by this reference, may likewise be used.

The crosslinkable component of the coating composition may further include one or more modifying resins, which are also known as nonaqueous dispersions (NADs). Such resins are sometimes used in order to adjust the viscosity of the coating composition obtained. The amount of modifying resin which can be used is typically in ranges from about 10 wt. % to about 50 wt. %, with all of the percentages being based on the total weight of crosslinkable component solids. The weight-average molecular weight (in g/mol) of the modifying resin, determined according to DIN 55672:2016-03, is in general in ranges from about 20 000 to about 100 000, preferably in ranges from about 25 000 to about 80 000, and more preferably in ranges from about 30 000 to about 50 000.

The crosslinkable or crosslinking component of the coating composition of the present invention typically comprises at least one organic solvent, selected typically from the group consisting of aromatic hydrocarbons, such as petroleum naphtha or xylenes; ketones, such as methyl amyl ketone, methyl isobutyl ketone, methyl ethyl ketone or acetone; esters, such as butyl acetate or hexyl acetate; and glycol ether esters, such as propylene glycol monomethyl ether acetate. The amount of organic solvent added is dependent on the desired solids fraction and also the desired amount of VOC in the composition. If desired, the organic solvent can be added to both components of the binder. A coating composition with high solids content and low VOC is preferred.

If control agents—below—for a low baking temperature are included with either the crosslinkable component, the crosslinking component or both in the coating composition (preferably with the crosslinkable component), the run resistance of the coat applied to a substrate surface can be improved, under the condition of a low baking temperature. The control agent for a low baking temperature in the present invention includes a rheological component. In one illustrative embodiment, the rheological component includes an amorphous silica gel, a clay, or a combination of both. In another illustrative embodiment, the control agent for a low baking temperature includes about 0.1 wt. % to about 10 wt. %, preferably about 0.3% to about 5 wt. %, more preferably about 0.5 wt. % to about 2 wt. % of the rheological component, and in the range from about 0.1 wt. % to about 10 wt. %, preferably in the range from about 0.3 wt. % to about 5 wt. %, and more preferably in the range from about 0.5 wt. % to about 2 wt. % of polyurea, with the wt. %ages being based on the total weight of the crosslinkable and crosslinking components of the curable coating composition with low baking of the present invention. If too little silica gel and polyurea are used (less than the ranges set out above), no advantage can be seen, and, if too much silica gel and polyurea are used (more than the ranges set out above), the coating surface obtained will be rough.

Amorphous silica gels that are suitable for use include colloidal silica gels, which have been partly or fully surface-modified by the silanization of hydroxyl groups on the silica gel particles, thereby rendering some or all of the silica gel particle surface hydrophobic. Examples of suitable hydrophobic silica gel include ÄROSIL R972, ÄROSIL R812, ÄROSIL OK412, ÄROSIL TS-100 and ÄROSIL R805, all of which are available commercially from Evonik Industries AG, Essen, Germany. Particularly preferred is pyrogenic silica gel from Evonik Industries AG, Essen, Germany, available as ÄROSIL R 812. Other commercially available silica gel includes SIBELITE M3000 (cristobalite), SIL-CO-SIL, ground silica gel, MIN-U-SIL, micronized silica gel, all being obtained from U.S. Kieselgel Company, Berkeley Springs, West Virginia.

The silica gel can be dispersed in the copolymer by a milling process using conventional equipment, such as high-speed blade mixers, ball mills or sand mills. Preferably the silica gel is dispersed separately in the above-described acrylic polymer, and then the dispersion can be added to the crosslinkable component of the coating composition.

The clay suitable for use herein may include clay, dispersed clay, or a combination thereof. Examples of commercially available clay products include bentonite clay, available as BENTONE from Elementis Specialties, London, Great Britain, and GARAMITE clay, available from Southern Ton Products, Gonzales, Tex., USA, under correspondingly registered trademarks. BENTONE 34 dispersion, described in U.S. Pat. No. 8,357,456, and GARAMITE dispersion, described in U.S. Pat. No. 8,227,544, and a combination of the two are suitable. It is also possible to use a combination of the silica gel and of the clay, such as the aforementioned BENTONE, the GARAMITE, or dispersions thereof.

The polyurea suitable for use in the control agent for a low baking temperature is obtained from the polymerization of a monomer mixture which includes about 0.5 to about 3 wt. % of the amine monomers, about 0.5 to about 3 wt. % of the isocyanate monomers, and about 94 to about 99 wt. % of a moderating polymer. The amine monomer is selected from the group consisting of a primary amine, secondary amine, ketimine, aldimine, or a combination thereof. Benzylamine is preferred. The isocyanate monomer is selected from the group consisting of an aliphatic polyisocyanate, cycloaliphatic polyisocyanate, aromatic polyisocyanate, and a combination thereof. The preferred isocyanate monomer is 1,6-hexamethylene diisocyanate or 1,5-pentamethylene diisocyanate. The moderating polymer may be one or more of the polymers described above. The acrylic polymers or polyesters are preferred.

The polyurea is preferably prepared by mixing one or more of the moderating polymers with the amine monomers and then adding isocyanate monomers over time under ambient conditions.

The run resistance of a coat from a pot mix or batch mix obtained by mixing the crosslinkable and crosslinking components of the present coating composition and applied to a substrate is in the range from about 5 (127 micrometers) to about 20 mils (508 micrometers) when measured by the ASTM test D4400-99. The larger the number, the higher the desired run resistance will be.

The coating composition is formulated preferably as a two-component coating composition, in which case the crosslinkable component is stored in a separate container from the crosslinking component, this composition being mixed in order to form a pot mix or batch mix shortly before use.

The coating composition is formulated preferably as an automotive OEM composition or as an automotive repair composition. These compositions may be applied in the form of a basecoat or a pigmented single-coating topcoat material to a substrate. These compositions require the presence of pigments. Used typically is a pigment-to-binder ratio of about 1.0/100 to about 200/100, depending on the color and nature of pigment to be used. The pigments are formulated in millbases by conventional methods, such as grinding, sand grinding, and high-speed mixing. The millbase generally comprises pigment and a dispersant in an organic solvent. The millbase is added in a suitable amount to the coating composition with mixing so as to form a pigmented coating composition.

Any of the organic and inorganic pigments customarily used, such as white pigments, for example titanium dioxide, color pigments, metallic flakes, for example aluminum flakes, special effect pigments, for example coated mica flakes and coated aluminum flakes, and extender pigments, may be used.

The coating composition may also include other conventional formulating additives, such as wetting agents, flow control agents and leveling agents, examples being Resiflow S (polybutyl acrylate), BYK 320 and 325 (polyacrylates of high molecular weight), BYK 347 (polyether-modified siloxane), defoamers, surfactants and emulsifiers, in order to support the composition during stabilization. Other additives which generally improve the resistance to damage may be added, such as silsesquioxanes and other silicate-based microparticles.

To improve the weathering resistance of the clear finish of the coating composition, it is possible to add about 0.1% to about 5 wt. %, based on the weight of the composition solids, of an ultraviolet light stabilizer or of a combination of ultraviolet light stabilizers and absorption agents. These stabilizers include ultraviolet light absorbers, screeners, quenchers, and special hindered amine light stabilizers. It is likewise possible to add about 0.1% to about 5 wt. %, based on the weight of the composition solids, of an antioxidant as well.

The coating composition is formulated preferably in the form of a two-component coating composition. The present invention can be used particularly as a basecoat material for outdoor articles, such as vehicles and other vehicle bodywork parts. The vehicle or the other vehicle bodywork part may be constructed from one or more materials. Suitable materials are, for example, metal, plastic or mixtures thereof. The vehicle may be any vehicle known to the person skilled in the art. For example, the vehicle may be a motor vehicle, heavy goods vehicle, motorcycle, moped, bicycle or the like. Preferably, the vehicle is a motor vehicle and/or heavy goods vehicle (HGV), particularly preferably a motor vehicle. A typical motor vehicle or HGV body is made from steel sheet or a plastics substrate or a composite material substrate. For example, the protective panels may be made of plastic or a composite, and the main part of the bodywork may be made of steel. If steel is used, it is first treated with an inorganic rust-preventive compound, such as zinc phosphate or iron phosphate, called an e-coat, and then a primer coating is applied, generally by electrodeposition. These electrodeposition primers are typically epoxy-modified resins, crosslinked with a polyisocyanate, and are applied by a cathodic electrodeposition method. Optionally it is possible for a primer to be applied over the electrodeposited primer, commonly by spraying, in order to provide improved appearance and/or improved adhesion of a basecoat system or of a single coating on the primer.

The known basecoat formulations may be used in either solventborne or aqueous form.

The basecoat film may be substantially free of melamine and its derivatives. “Substantially free” in this context means more particularly that melamine and its derivatives are present in the basecoat film in amounts of less than 5 wt. %, preferably less than 3 wt. %, and more preferably less than 1 wt. %, based on the total weight of the nonvolatile components of the basecoat film. Melamine or derivatives thereof present in these amounts in the basecoat film do not make any significant contribution to the crosslinking of the basecoat film in the course of curing with supply of heat.

According to one preferred embodiment of the invention, the basecoat film is substantially free of melamine and its derivatives.

In embodiments in which, for example, a further improvement in intercoat adhesion and an even higher degree of crosslinking of the basecoat is important, it has been found to be advantageous when the basecoat of the invention comprises at least one NCO-reactive compound. NCO-reactive compounds suitable for the basecoat are polyether polyols, polycarbonate polyols, polyester polyols, polyacrylate polyols, polyurethane polyols, polyacrylate polyols, as already described further up for the clearcoat. The NCO-reactive compound used in the basecoat is preferably one or more selected from polyester polyols, polyacrylate polyols and/or polyurethane polyols.

The basecoat may comprise at least one NCO-reactive compound.

The basecoat material may be a one-component coating material and may have no pot life. In this context, “no pot life” means that the application-ready basecoat material is storage-stable for more than 7 days, preferably more than 2 weeks, more preferably more than 4 weeks, i.e. can be used with the same properties as freshly prepared even after 7 days, 2 weeks or 4 weeks.

The topcoat of the invention has greater than or equal to 40 wt. % and less than or equal to 100 wt. % of silane group-containing prepolymers and/or crosslinking products thereof. The weight % figure here is based on the dried and cured topcoat. The prepolymers used here may have one or more silane groups per prepolymer. The prepolymers therefore have at least one functional group composed of a silicon framework and hydrogen. This functional group may be, for example, —SiH₃. The hydrogens may be further substituted by additional groups, examples being alkyl or alkoxy groups. The silane group-containing prepolymers here may be present as such or in the form of crosslinking products of higher molecular weight, as a function of specific crosslinking or curing, for example. The degree of crosslinking and, connected with it, the different fractions of monomers and polymers of higher molecular weight here are a function of the reaction conditions, the composition of the topcoat, and the monomers present. In preferred embodiments, the fraction of the silane group-containing prepolymers may be greater than or equal to 50 wt. % and less than or equal to 100 wt. %, and more preferably greater than or equal to 75 wt. % and less than or equal to 100 wt. %. The silane groups of the silane group-containing prepolymers are the crosslink-forming group, meaning that they react to form a siloxane group.

Described below is the structure of the silane-functional prepolymers which can be used in the invention in the topcoat, and the structure of the polymeric crosslinking products possibly formed from them.

A silane-functionalized, polymeric polyisocyanate having at least one alkoxysilane group may be provided as a silane-functional prepolymer preferred in the invention in the context of one further embodiment. Said silane-functionalized, polymeric polyisocyanates may be synthesized by the direct reaction of polymeric polyisocyanates with alkoxysilanes which carry an isocyanate-reactive group such as amino, mercapto or hydroxyl. Suitable polymeric polyisocyanates used are aromatic, araliphatic, aliphatic or cycloaliphatic polymeric polyisocyanates having an NCO functionality >2. They may also have iminooxadiazinedione, isocyanurate, uretdione, urethane, allophanate, biuret, urea, oxadiazinetrione, oxazolidinone, acylurea and/or carbodiimide structures, and can be prepared by the usual methods.

Suitable diisocyanates for preparing the polymeric polyisocyanates are any suitable diisocyanates of those stated above, and those stated as preferred, or any desired mixtures of these diisocyantes. Especially suitable for preparing said silane-functional polymeric polyisocyanates are dimers of the aforesaid diisocyantes, trimers of the aforesaid diisocyanates, or combinations thereof, as polymeric polyisocyanate of the invention.

In a further embodiment, the silane-functional prepolymer is a silane-functional prepolymer obtainable by the reaction of an isocyanatosilane with a polymer which has functional end groups that are reactive toward isocyanate groups, more particularly hydroxyl groups, mercapto groups and/or amino groups.

The alkoxysilane-functional isocyanates are any desired compounds in which at least one, preferably precisely one, isocyanate group and at least one, preferably precisely one, silane group having at least one alkoxy substituent are simultaneously present alongside one another. The alkoxysilane-functional isocyanate is hereinbelow also referred to as isocyanatoalkoxysilane.

Suitable isocyanatoalkoxysilanes include for example isocyanatoalkylalkoxysilanes, such as are obtainable for example by the processes described in U.S. 3,494,951, EP-A 0 649 850, WO 2014/063895 and WO 2016/010900 via a phosgene-free route by thermal cleavage of the corresponding carbamates or ureas.

Preferred polymers containing functional end groups reactive toward isocyanate groups are the above-stated polymeric polyols, especially polyether, polyester, polycarbonate and polyacrylate polyols, and also polyurethane polyols, prepared from polyisocyanates and the stated polyols. It is also possible to use mixtures of all stated polyols.

According to a further preferred embodiment, the alkoxysilane-functional isocyanate employed is at least one compound of the general formula

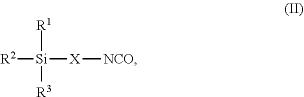

in which

R¹, R² and R³ independently of one another represent identical or different saturated or unsaturated linear or branched, aliphatic or cycloaliphatic or optionally substituted aromatic or araliphatic radicals having up to 18 carbon atoms which may optionally contain up to 3 heteroatoms from the group of oxygen, sulfur, nitrogen, preferably in each case alkyl radicals having up to 6 carbon atoms and/or alkoxy radicals having up to 6 carbon atoms which may contain up to 3 oxygen atoms, particularly preferably in each case methyl, methoxy and/or ethoxy, with the proviso that at least one of the radicals R¹, R² and R³ is connected to the silicon atom via an oxygen atom and

X represents a linear or branched organic radical having up to 6, preferably 1 to 4, carbon atoms, particularly preferably a propylene radical (—CH2—CH2—CH2—).

Examples of such isocyanatoalkoxysilanes include isocyanatomethyltrimethoxy silane, isocyanatomethyltriethoxysilane, isocyanatomethyltriisopropoxysilane, 2-isocyanatoethyltrimethoxysilane, 2-isocyanatoethyltriethoxysilane, 2-isocyanatoethyltriisopropoxysilane, 3-isocyanatopropyltrimethoxysilane, 3-isocyanatopropyltriethoxysilane, 3-isocyanatopropylmethyldimethoxysilane, 3-isocyanatopropylmethyldiethoxysilane, 3-isocyanatopropylethyldiethoxysilane, 3-isocyanatopropyldimethylethoxysilane, 3-isocyanatopropyldiisopropylethoxysilane, 3-isocyanatopropyltripropoxysilane, 3-isocyanatopropyltriisopropoxysilane, 3-isocyanatopropyltributoxysilane, 3-isocyanatopropylmethyldibutoxysilane, 3-isocyanatopropylphenyldimethoxysilane, 3-isocyanatopropylphenyldiethoxysilane, 3-isocyanatopropyltris(methoxyethoxyethoxy)silane, 2-isocyanatoisopropyltrimethoxysilane, 4-isocyanatobutyltrimethoxysilane, 4-isocyanatobutyltriethoxysilane, 4-isocyanatobutyltriisopropoxysilane, 4-isocyanatobutylmethyldimethoxysilane, 4-isocyanatobutylmethyldiethoxysilane, 4-isocyanatobutylethyldimethoxysilane, 4-isocyanatobutylethyldiethoxysilane, 4-isocyanatobutyldimethylmethoxysilane, 4-isocyanatobutylphenyldimethoxysilane, 4-isocyanatobutylphenyldiethoxysilane, 4-isocyanato(3-methylbutyl)trimethoxysilane, 4-isocyanato(3-methylbutyl)triethoxysilane, 4-isocyanato(3-methylbutyl)methyldimethoxysilane, 4-isocyanato(3-methylbutyl)methyldiethoxysilane and 11-isocyanatoundecyltrimethoxysilane or any desired mixtures of such isocyanatoalkoxysilanes.

Suitable isocyanatoalkoxysilanes also include for example isocyanatosilanes having a thiourethane structure such as are obtainable by the process in WO 2014/037279 by reaction of any desired aliphatic, cycloaliphatic, araliphatic or aromatic diisocyanates with any desired mercaptosilanes in an NCO: SH ratio of 6: 1 to 40: 1 and subsequent removal of excess unconverted monomeric diisocyanates by thin-film distillation.

According to a further preferred embodiment, the isocyanatoalkoxysilane employed is at least one compound according to the general formula

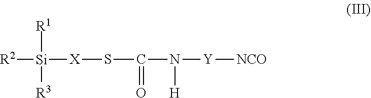

which is present in a mixture with minor amounts of the corresponding bis-adduct, in which both isocyante groups of the diisocyanate have undergone reaction with the mercaptosilane, where, in formula (III) and the bis-adduct
R¹, R² and R³ independently of one another represent identical or different saturated or unsaturated linear or branched, aliphatic or cycloaliphatic or optionally substituted aromatic or araliphatic radicals having up to 18 carbon atoms which may optionally contain up to 3 heteroatoms from the group of oxygen, sulfur, nitrogen, preferably in each case alkyl radicals having up to 6 carbon atoms and/or alkoxy radicals having up to 6 carbon atoms which may contain up to 3 oxygen atoms, particularly preferably in each case methyl, methoxy and/or ethoxy with the proviso that at least one of the radicals R′, R² and R³ is connected to the silicon atom via an oxygen atom,
X is a linear or branched organic radical having up to 6, preferably 1 to 4, carbon atoms, particularly preferably a propylene radical (—CH₂—CH₂—CH₂—) and
Y is a linear, branched or cyclic organic radical. This may be an aromatic or aliphatic radical, preferably a unit or a mixture selected from the group consisting of isophoronyl, pentamethylene, hexamethylene, biscyclohexylmethylene, toluidenyl or methylenediphenylene .

The isocyanatosilanes of the formula (III) can be reacted preferably with polyols to give silane group-containing prepolymers according to the general formula

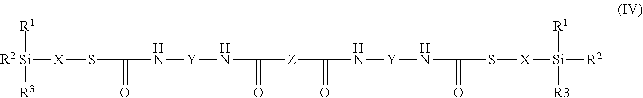

where in the formula (IV)

R¹, R² and R³ independently of one another represent identical or different saturated or unsaturated linear or branched, aliphatic or cycloaliphatic or optionally substituted aromatic or araliphatic radicals having up to 18 carbon atoms which may optionally contain up to 3 heteroatoms from the group of oxygen, sulfur, nitrogen, preferably in each case alkyl radicals having up to 6 carbon atoms and/or alkoxy radicals having up to 6 carbon atoms which may contain up to 3 oxygen atoms, particularly preferably in each case methyl, methoxy and/or ethoxy, with the proviso that at least one of the radicals R¹, R² and R³ is connected to the silicon atom via an oxygen atom,
X is a linear or branched organic radical having up to 6, preferably 1 to 4, carbon atoms, particularly preferably a propylene radical (—CH₂—CH₂—CH₂—) and
Y is a linear, branched or cyclic organic radical. This may be an aromatic or aliphatic radical, preferably a unit or a mixture selected from the group consisting of isophoronyl, pentamethylene, hexamethylene, biscyclohexylmethylene, toluidenyl or methylenediphenylene,
Z is a structural unit derived from an at least difunctional polyol which has a number-average molecular weight Mₙ of 270 to 22 000 g/mol, preferably of 500 to 18 000 g/mol and more preferably of 800 to 12 000 g/mol. The polyol preferably also has an acid number, determined according to DIN EN ISO 2114:2002-06, of 0.01 to 30.0 mg KOH/g, preferably 0.1 to 25.0 mg KOH/g, more preferably 0.2 to 20.0 mg KOH/g, based in each case on the solids content of the polyol. The polyol is more preferably a polyester polyol, polycarbonate polyol and/or polyacrylate polyol, preferably having a mean OH functionality of 2 to 6 and more preferably of 2 to 4.

Suitable and preferred polyols from which the structural unit Z in the formula (IV) derives are the (polymeric) polyols already described above in the text, with the same preferences applying. Such suitable and preferred polyols and silane-functional prepolymers obtained from them are the compounds disclosed in WO 2018/029197, which can be prepared preferably by the processes described there.

Alternatively or in combination to the above definition of Z in the formula (IV), Z, according to a further embodiment of the method of the invention, is a structural unit which derives from a polyhydric alcohol and/or ether alcohol or ester alcohol as polyol, containing 2 to 14 carbon atoms, preferably 4 to 10 carbon atoms.

Polyols of this kind that are suitable alternatively or in combination to the above definition of Z in the formula (IV), also referred to as of low molecular weight, are polyhydric alcohols and/or ether alcohols or ester alcohols such as, for example, 1,2-ethanediol, 1,2- and 1,3-propanediol, the isomeric butanediols, pentanediols, hexanediols, heptanediols and octanediols, 1,10-decanediol, 1,12-dodecanediol, 1,2- and 1,4-cyclohexanediol, 1,4-cyclohexanedimethanol, 1,4-bis(2-hydroxyethoxy)benzene, 2,2-bis(4-hydroxyphenyl)propane (bisphenol A), 2,2-bis(4-hydroxycyclohexyl)propane (perhydrobisphenol), 1,2,3-propanetriol, 1,2,4-butanetriol, 1,1,1-trimethylolethane, 1,2,6-hexanetriol, 1,1,1-trimethylolpropane (TMP), bis(2-hydroxyethyl)hydroquinone, 1,2,4- and 1,3 ,5-trihydroxycyclohexane, 1,3 ,5-tris(2-hydroxyethyl) isocyanurate, bis(hydroxymethyl)tricyclo [5.2.1. 0^{2,6}]decane, 4,8-bis(hydroxymethyl)tricyclo[5 .2.1. 0^{2,6}] decane and 5,8-bis(hydroxymethyl)tricyclo [5.2.1.0′] containing Jdecane, where the compounds may be present individually or in an isomer mixture, ditrimethylolpropane, 2,2-bis(hydroxymethyl)propane-1,3-diol (pentaerythritol), 2,2,6,6-tetrakis(hydroxymethyl)-4-oxaheptane-1,7-diol (dipentaerythritol), mannitol or sorbitol, low molecular weight ether alcohols, for example diethylene glycol, triethylene glycol, tetraethylene glycol, dipropylene glycol or dibutylene glycol, or low molecular weight ester alcohols, for example neopentyl glycol hydroxypivalate.

Preferred examples of such isocyanatosilanes having a thiourethane structure are the reaction products of 2-mercaptoethyltrimethylsilane, 2-mercaptoethylmethyldimethoxysilane, 2-mercaptoethyltrimethoxysilane, 2-mercaptoethyltriethoxysilane, 3-mercaptopropylmethyldimethoxysilane, 3-mercaptopropyldimethylmethoxysilane, 3-mercaptopropyltrimethoxysilane, 3-mercaptopropylmethyldiethoxysilane, 3-mercaptopropyltriethoxysilane, 3-mercaptopropylethyldiethoxysilane and/or 4-mercaptobutyltrimethoxysilane with 1,5-diisocyanatopentane, 1, 6-diisocyanatohexane, 1-isocyanato-3 ,3,5-trimethyl-5-isocyanatomethylcyclohexane, 2,4′- and/or 4,4′-diisocyanatodicyclohexylmethane or any desired mixtures of these diisocyanates.

Particularly preferred alkoxysilane-functional isocyanates for the method of the invention are isocyanatomethyltrimethoxysilane, isocyanatomethyltriethoxysilane, 3-isocyanatopropyltrimethoxysilane and 3-isocyanatopropyltriethoxysilane, the isocyanatosilanes having a thiourethane structure obtainable by the process of WO 2014/037279 by reaction of 3-mercaptopropyltrimethoxysilane and/or 3-mercaptopropyltriethoxysilane with 1,5-diisocyanatopentane, 1,6-diisocyanatohexane, 1-isocyanato-3 ,3,5-trimethyl-5-isocyanatomethylcyclohexane, 2,4′- and/or 4,4′-diisocyanatodicyclohexylmethane and any desired mixtures of such isocyanatosilanes.

The use of the recited isocyanatosilanes having a thiourethane structure is especially preferred.

To obtain the silane-functional prepolymers suitable for the present invention, in the case of the process described in WO 2018/029197, after the reaction, preferably following the reaction of the at least one above-described polymeric polyol or low molecular weight polyol, or of a mixture of both, with the at least one above, the reaction product obtained is reacted, in a further process step, with at least one alkoxysilane-functional isocyanate. Before the reaction with the alkoxysilane-functional isocyanate, the reaction product obtained may optionally be subjected to any further intermediate steps, provided that during the reaction with the at least one alkoxysilane-functional isocyanate, a sufficient amount of hydroxyl groups is still present in the reaction product. However, it is particularly preferable when the reaction of the reaction product with the alkoxysilane-functional isocyanate is carried out without intermediate steps.

Suitable isocyanatoalkoxysilanes likewise include for example those having a formylurea structure such as are obtainable by the process of WO 2015/113923 by reaction of formamide-containing silanes with molar excesses of any desired aliphatic, cycloaliphatic, araliphatic or aromatic diisocyanates and subsequent distillative removal of unconverted monomeric diisocyanates.

In a further preferred embodiment the employed isocyanatoalkoxysilane is at least one compound of general formula (IV)

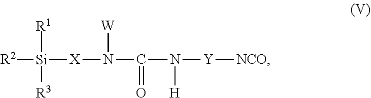

which is present in admixture with subordinate amounts of silane-functional compounds of general formula (VI),

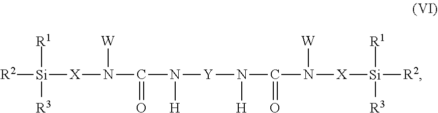

wherein in formulae (IV) and (VI)

R¹, R² and R³ independently of one another represent identical or different saturated or unsaturated linear or branched, aliphatic or cycloaliphatic or optionally substituted aromatic or araliphatic radicals having up to 18 carbon atoms which may optionally contain up to 3 heteroatoms from the group of oxygen, sulfur, nitrogen, preferably in each case alkyl radicals having up to 6 carbon atoms and/or alkoxy radicals having up to 6 carbon atoms which may contain up to 3 oxygen atoms, particularly preferably in each case methyl, methoxy and/or ethoxy, with the proviso that at least one of the radicals R¹, R² and R³ is connected to the silicon atom via an oxygen atom,
X represents a linear or branched organic radical having up to 6, preferably 1 to 4, carbon atoms, particularly preferably a propylene radical (—CH2—CH2—CH2—), and
Y represents a linear or branched, aliphatic or cycloaliphatic radical having 4 to 18 carbon atoms or an optionally substituted aromatic or araliphatic radical having 6 to 18 carbon atoms, preferably a linear or branched, aliphatic or cycloaliphatic radical having 6 to 13 carbon atoms, and
W independently at each occurrence is a formyl or acetyl group or else a COO group with a radical G. G here may be mono-, di-, tri- or tetrafunctional and is a linear or branched, aliphatic or cycloaliphatic radical or a connecting unit derived therefrom and having 4 to 18 carbon atoms, or an optionally substituted aromatic or araliphatic radical or a connecting unit derived therefrom and having 6 to 18 carbon atoms, preferably a linear or branched, aliphatic or cycloaliphatic radical having 6 to 13 carbon atoms. The radical W may optionally include one or more heteroatoms selected from the group of oxygen, sulfur and nitrogen.

Examples of such isocyanatosilanes having a formylurea structure include the reaction products of formamide silanes such as are obtainable for example by the process disclosed in WO 2015/113923 by reaction of primary amino-bearing amino silanes, in particular 3-aminopropyltrimethoxysilane and/or 3-aminopropyltriethoxysilane, with alkyl formates, preferably with methyl formate and/or ethyl formate, with elimination of alcohol, with aliphatic and/or cycloaliphatic diisocyanates, preferably 1,5-diisocyanatopentane, 1,6-diisocyanatohexane, 1-isocyanato-3,3,5-trimethyl-5-isocyanatomethylcyclohexane, 2,4′-and/or 4,4′-diisocyanatodicyclohexylmethane or any desired mixtures of these diisocyanates.

Additionally preferred is the use of at least one N-formylaminoalkylsilane of the formula (IX) as isocyanate-reactive alkoxysilane component for the synthesis of prepolymers containing alkoxysilyl groups

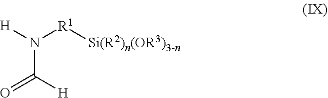

in which R¹ is an at least divalent, optionally substituted, linear or branched, aliphatic, alicyclic, araliphatic and/or aromatic structural unit having 1 to 12 carbon atoms, in which one or more nonadjacent methylene groups may have been replaced by O or S,

R² and R³ each independently of one another are a linear or branched, aliphatic group having 1 to 12 carbon atoms, which may be substituted, and n is the number 0, 1 or 2. Preferred compounds of the formula (IX) are selected from N-(3-triethoxysilylpropyl)formamide, N-(3-methyldiethoxysilylpropyl)formamide, N-(3-trimethoxysilylpropyl)formamide, N-(3-methyldiethoxymethylsilylpropyl)formamide, or mixtures thereof. Corresponding compounds and also alkoxysilyl group-containing prepolymers resulting from them are disclosed in the publication US 2016/340372 A1, to which reference is expressly made in its entirety.

Further suitable isocyanatoalkoxysilanes are also the 1:1 monoadducts, prepared for example by the process of EP-A 1 136 495, of diisocyanates and specific secondary aminoalkylalkoxysilanes, the aspartic esters known from EP-A 0 596 360 and obtainable by reaction of dialkyl maleates with aminosilanes, where the reaction partners are reacted with one another using a large molar isocyanate excess, and subsequently the unconverted monomeric diisocyanates are removed by distillation.

Also used as isocyanate-reactive compounds, preferably, are aspartic esters of the kind described in EP-A-0 596 360. In these molecules of the general formula (VIII)

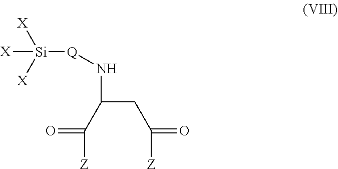

X denotes identical or different alkoxy or alkyl radicals, which may also be bridged, but where there must be at least one alkoxy radical present on each Si atom,

Q is a difunctional linear or branched aliphatic radical and Z is an alkoxy radical having 1 to 10 carbon atoms. The use of such aspartic esters is preferred. Examples of particularly preferred aspartic esters are diethyl N-(3-triethoxysilylpropyl)asparate, diethyl N-(3-trimethoxysilylpropyl)asparate and diethyl N-(3-dimethoxymethylsilylpropyl)asparate. Especially preferred is the use of diethyl N-(3-triethoxysilylpropyl)asparate. Corresponding prepolymers A) prepared from compounds of the formula (VIII) are those as described and prepared in EP-A-0 994 117.

The alkoxysilyl-functionalized prepolymers of publication EP 2 641 925 A and the publication DE 10 2012 204290 A are also each of preferential suitability in the context of this invention.

The silane-functionalized thioallophanates of publication WO 2015/189164 are isocyanate-functional silanes of the formula (VII) which can be used with particular preference

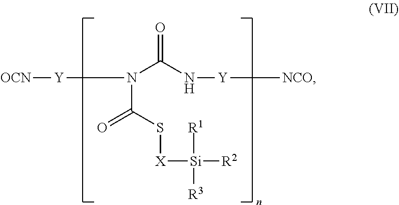

in which

R¹, R² and R³ independently of one another are identical or different radicals and are each a saturated or unsaturated, linear or branched, aliphatic or cycloaliphatic or an optionally substituted aromatic or araliphatic radical having up to 18 carbon atoms, which may optionally contain up to 3 heteroatoms from the series of oxygen, sulfur and nitrogen,

X is a linear or branched organic radical having at least 2 carbon atoms,

Y is a linear or branched, aliphatic or cycloaliphatic, an araliphatic or aromatic radical having up to 18 carbon atoms and

N is an integer from 1 to 20.

They are preferably reacted with at least one polyol to give a silane-functional prepolymer. Suitable polyols are the polyols stated above preferably (vide supra).

The reaction of the isocyanatosilanes as depicted illustratively in formula (II), (III), (V) and (VII), with the isocyanate-reactive groups, with the polyols preferably used takes place in the same way as described above for the preparation of the isocyanate-containing prepolymer, from the polyisocyanate component with the polyol component.

Suitable and preferred polyols from which the structural unit Z in the formula (IV) derives are the (polymeric) polyols already described above in the text, with the same preferences applying. Such suitable and preferred polyols and silane-functional prepolymers obtained from them are the compounds disclosed in WO 2018/029197, which can be prepared preferably by the processes described there.

Alternatively or in combination to the above definition of Z in the formula (IV), Z, according to a further embodiment of the method of the invention, is a structural unit which derives from a polyhydric alcohol and/or ether alcohol or ester alcohol as polyol, containing 2 to 14 carbon atoms, preferably 4 to 10 carbon atoms.

Alternatively or in combination to the above definition of Z in the formula (IV), suitable polyols, also referred to as of low molecular weight, are polyhydric alcohols and/or ether or ester alcohols such as, for example, 1,2-ethanediol, 1,2- and 1,3-propanediol, the isomeric butanediols, pentanediols, hexanediols, heptanediols and octanediols, 1,10-decanediol, 1,12-dodecanediol, 1,2 and 1,4-cyclohexanediol, 1,4-cyclohexanedimethanol, 1,4-bis(2-hydroxyethoxy)benzene, 2,2-bis(4-hydroxyphenyl)propane (bisphenol A), 2,2-bis(4-hydroxycyclohexyl)propane (perhydrobisphenol), 1,2,3-propanetriol, 1,2,4-butanetriol, 1,1,1-trimethylolethane, 1,2,6-hexanetriol, 1,1,1-trimethylolpropane (TMP), bis(2-hydroxyethyl)hydroquinone, 1,2,4- and 1,3,5-trihydroxycyclohexane, 1,3 ,5-tris(2-hydroxyethyl) isocyanurate, bis(hydroxymethyl)tricyclo[5.2.1. 0^{2′6}]decane, 4,8-bis(hydromethyl)tricyclo[5 .2.1.0^{2,6}]decane and 5,8-bis(hydroxymethyl)tricyclo[5.2.1.0′]containing Jdecane, where the compounds may be present individually or in an isomixture, ditrimethylpropane, 2,2-bis(hydroxymethyl)1,3-propanediol(pentaerythritol), 2,2,6,6-tetrakis(hydroxymethyl)-4-oxaheptane-1,7-diol (dipentaerythritol), mannitol or sorbitol, low molecular weight ether alcohols, for example diethylene glycol, triethylene glycol, tetraethylene glycol, dipropylene glycol or dibutylene glycol, or low molecular weight ester alcohols, for example neopentyl glycol hydroxypivalate hydroxypivalate.

Preferred is the reaction of the isocyanatosilane of the formula (V) first with a monofunctional alcohol such as methanol, ethanol, Propan-1-ol, propan-2-ol, 1-butanol, 2-butanol 1-pentanol, 1-hexanol, 1-heptanol, 2-ethylhexanol, 1-octanol, 1-nonanol and 1-decanol. The reaction takes place to an extent of at least 50 wt. % of the NCO groups of the isocyanatosilane (V), more preferably with up to 60 wt. % and very preferably with up to 70% of the monofunctional alcohol converted.

The ratio of the NCO groups in the isocyanatosilane to the isocyanate-reactive groups, preferably the hydroxyl groups of the polyols, is between 0.5: 1 and 1: 1, preferably between 0.75: 1 and 1: 1, very preferably between 0.9: 1 and 1: 1.

As described in patents US 2017/0369626, US 2017/0369627 and US 2017/0369631, it is also possible to prepare silane group-containing monoisocyanates by reaction of isocyantosilanes with amino-, hydroxy- and mercapto-functional building blocks and subsequent allophanatization with an excess of above-described diisocyanates.

Suitable isocyantosilanes or isocyanate-functional alkoxysilane compounds are in principle all monoisocyanates containing alkoxysilane groups and having a molecular weight of 145 g/mol to 800 g/mol. Examples of such compounds are isocyanatomethyltrimethoxysilane, isocyanatomethyltriethoxysilane, (isocyanatomethyl)methyldimethoxysilane, (isocyanatomethyl)-methyldiethoxysilane, 3-isocyanatopropyltrimethoxysilane, 3-isocyanatopropylmethyl-dimethoxysilane, 3-isocyanatopropyltriethoxysilane and 3-isocyanatopropylmethyl-diethoxysilane. Preferred here is the use of 3-isocyanatopropyltrimethoxysilane or 3-isocyanatopropyltriethoxysilane; especially preferred is the use of 3-isocyanatopropyltrimethoxysilane.

It is, however, also possible to use isocyanate-functional alkoxysilane compounds of higher molecular weight. Here it is possible in the invention to use isocyanate-functional silanes which have been prepared by reaction of a diisocyanate with an aminosilane or thiosilane, of the type described in U.S. Pat. No. 4,146,585 or EP-A 1 136 495.

Suitable solvents are especially those which are inert toward the reactive groups of the isocyanatosilanes, for example the known customary aprotic varnish solvents, for example ethyl acetate, butyl acetate, ethylene glycol monomethyl ether acetate or monoethyl ether acetate, 1-methoxyprop-2-yl acetate, 3-methoxy-n-butyl acetate, acetone, 2-butanone, 4-butyl-2-pentanone, cyclohexanone, toluene, xylene, chlorobenzene, petroleum spirit, aromatics having a relatively high degree of substitution, as commercially available, for example, under the Solvent naphtha, Solvesso, Isopar, Nappar (Deutsche EXXON CHEMICAL GmbH, Cologne, Del.) and Shellsol (Deutsche Shell Chemie GmbH, Eschborn, Del.) names, but also solvents such as propylene glycol diacetate, diethylene glycol dimethyl ether, dipropylene glycol dimethyl ether, diethylene glycol ethyl and butyl ether acetate, ethyl ethoxypropionate, propylene carbonate, N-methylpyrrolidone and N-methylcaprolactam, or any desired mixtures of such solvents.

In a further embodiment the silane-functional polymer is a silane-functional polymer obtainable by a hydrosilylation reaction of polymers having terminal double bonds, examples being poly(meth)acrylate polymers and polyether polymers, more particularly of allyl terminated polyoxyalkylene polymers, described for example in U.S. Pat. Nos. 3,071,751 and 6,207,766.

Depending on the field of application desired, for all of the stated isocyanate-reactive silane components, the methoxy derivatives and ethoxysilane derivatives are preferred for use in corrosion control and in the automotive refinish sector.

The prepolymers containing alkoxysilyl groups that can be used in the invention are prepared using isocyanate-reactive alkoxysilane compounds, by converting isocyanate-functional prepolymer (preferably isocyanate-functional polyurethane or polymeric polyisocyanates) by reaction with an isocyanate-reactive alkoxysilane compound (especially the aforesaid preferred isocyanate-reactive alkoxysilane compounds) to give the silane-terminated prepolymer. Said conversion with isocyanate-reactive alkoxysilanes takes place within a temperature range from 0° C. to 150° C., preferably from 20° C. to 120° C., with the proportions being chosen generally such that 0.8 to 1.3 mol of the isocyanate-reactive alkoxysilane compound are used per mole of NCO groups employed, preferably 1.0 mol of isocyanate-reactive alkoxysilane compound per mole of NCO groups employed.

As well as the structuring components of the basecoat material, this material may also comprise greater than or equal to 0.5 wt. % and less than or equal to 15 wt. % of silane group-containing prepolymers and/or crosslinking products thereof. Without being tied to the theory, the silane group-containing prepolymers of the topcoat are also capable of diffusing into the basecoat, and this may result in the preferred mechanical properties of the composite coating. The amount of silane group-containing prepolymers in the basecoat may be determined, for example, via a quantitative EDX as described in the examples, or conventionally via GPC. The fraction of silane group-containing prepolymers (or crosslinking products thereof) may preferably also be greater than or equal to 2 wt. % and less than or equal to 9 wt. %, more preferably greater than or equal to 3 wt. % and less than or equal to 8 wt. %.

In one preferred embodiment, the silane group-containing prepolymers and/or crosslinking products thereof may form a concentration gradient in the basecoat material. This means that the concentration of these components in the basecoat is not constant, but instead that the concentration of this component at the lower border of the basecoat is lower and then rises over the basecoat toward the topcoat. This formation may contribute to particularly firm adhesion of the two coats. The basecoat preferably has a difference in the concentration of the silane group-containing prepolymers from bottom to top of at least 25 mol %, preferably 50 mol % and more preferably 75 mol %. The gradient may be determined by means of quantitative FTIR (according to DIN EN 16602-70-05:2014-02) on different sections through the basecoat.

In one preferred embodiment of the composite coating, the silane group-containing prepolymers or their crosslinking products may be selected from the group consisting of polyurethanes, polymeric polyisocyanates, reaction products of polymeric polyols with silane-containing compounds, polyether polyols, polyester polyols, polycarbonate polyols, polyacrylate polyols, polymethacrylate polyols, polyurea, polyurethane polyols, or mixtures thereof, where the individual prepolymers of this group definition each carry at least one alkoxysilane group. The prepolymers of the aforementioned group that possess alkoxysilane units, in particular, may contribute to particularly efficient diffusion of the crosslinked or noncrosslinked prepolymers into the basecoat. In this way, mechanically very stable composite coatings with an excellent weathering stability may result. Further properties of these preferred prepolymer classes are recited earlier on above, as well as elsewhere.

In one preferred embodiment, the silane group-containing crosslinking products may have urethane structures. The construction of these layers from silane group-containing crosslinking products having urethane structures, in particular, may contribute to particularly strong adhering coats with good optical properties and good resistance.

In the composite coating of the invention, the silane group-containing prepolymers and/or crosslinking products thereof have at least one thiourethane unit and/or urethane unit in the molecule. These silane-terminated prepolymers may be obtained, for example, by reaction of isocyanate-functional silanes and thiourethane structure, and possess at least one simple alcohol, polyether, polyester, polycarbonate, polyurethane and/or polyacrylate structural units, bonded chemically via at least two urethane groups. Preference is given to polyacrylate structural units chemically bonded via at least one, via at least two urethane groups. These silane group-containing prepolymers may contribute to particularly advantageous mechanical properties on the part of the composite coating. Without being tied to the theory, this may be because of the interactions of the thiourethane units with the polymers of the basecoat.

In another aspect of the composite coating, the silane group-containing prepolymers and/or crosslinking products thereof may be selected from the group consisting of reaction products of silane-functional compounds bearing isocyanate groups with low molecular weight alcohols, polyacrylate polyols, polyester polyols, polysiloxane polyols, or mixtures thereof. This specific group of silane group-containing prepolymers may be capable of particularly efficient diffusion into the above-claimed group of basecoats. As a result it is possible to obtain composite coatings which have particularly preferred optical properties such as transparency, and these silane group-containing prepolymers may lead to particularly good weathering resistance on the part of the composite.

In a further preferred aspect of the composite coating, the silane group-containing prepolymers and/or crosslinking products thereof and prepared using isocyanate functionalities have a residual NCO content, determined according to DIN EN ISO 11909:2007-05 of greater than or equal to 0.0005% and less than or equal to 1%.

In one preferred embodiment of the composite coating, the topcoat may comprise catalysts selected from the group consisting of phosphoric acid, dibutyl phosphate, bis(ethylhexyl phosphate), dimethyl phosphate, methyl phosphate, trimethyl phosphate, phenylphosphonic acid, phenylphosphinic acid, or mixtures thereof in a concentration of greater than or equal to 0.25 wt. % and less than or equal to 2.5 wt. %, preferably greater than or equal to 0.25 wt. % and less than or equal to 2 wt. %, based on the topcoat. The possibility of the controlled diffusion of the silane group-containing prepolymers of the topcoat may also be accomplished by the selection of catalysts of the topcoat. To develop sufficient diffusion of the prepolymers of the topcoat, the catalysts specified above have proven very suitable. Without being tied to the theory, these catalysts may contribute to the development of an extremely efficient crosslinking of the topcoat with simultaneous development of a suitable diffusion gradient of the silane group-containing prepolymers in the basecoat. It appears that the kinetic control of the crosslinking reaction of the silane group-containing prepolymers in the topcoat is such that the silane group-containing prepolymers are able to diffuse very well into the basecoat for a sufficiently long period. The concentration of the catalysts in the topcoat may preferably be greater than or equal to 0.25 wt. % and less than or equal to 1.5 wt. %. The concentration of the catalysts in this case may be accomplished for example on a dissolved topcoat by way of HPLC. Smaller concentrations may be a disadvantage, since in that case the coats only cure very slowly and/or do not achieve the requisite film hardness. Higher concentrations may be a disadvantage, since the coat cures unevenly owing to a high reaction rate, rather than at equilibrium.

In one preferred aspect of the composite coating, the upper topcoat may have, at a layer thickness of 50 μm on a white basecoat, a delta-Lab value in relation to white basecoat material of ΔL greater than or equal to 0.2 and less than or equal to 20, of Δa greater than or equal to −0.01 and less than or equal to −20, and Δb greater than or equal to −0.01 and less than or equal to −13, determined in accordance with DIN EN ISO 1166-4:2012-06. With the method of the invention it is also possible in particular to obtain clear topcoat materials, i.e. clearcoat materials, which have little or no adverse effect at all on the visual properties, especially the color, of basecoats. Very homogeneous and transparent topcoats can therefore be obtained.

In one preferred embodiment of the composite coating, the composite coating may have a pendulum hardness, measured to DIN EN ISO 1522:2000-09, of greater than or equal to 60 s and less than or equal to 180 s. The composite coating of the invention displays particular viscoelastic properties. In particular, the construction according to the invention may contribute to the provision of highly elastic composite coatings, which can lead to suitable service properties for the composite coating as a whole. The improved elasticity may contribute, for example, to a reduction in the extent of ruptured paint on auto bodies because of mechanical exposures, such as stonechipping, for example.

In a further characteristic of the composite coating, the basecoat may have a fraction of greater than or equal to 2.5% and less than or equal to 30% of the catalyst used in the topcoat. In order to form a mechanically very robust composite coating, it has likewise emerged as advantageous that not only the silane group-containing prepolymers diffuse into the basecoat but also that the construction of the composite coating is such that a fraction of the catalyst used in the topcoat as well is able to diffuse into the basecoat. This may improve the adhesion of the two coats to one another, and lead to particularly preferred mechanical properties.

In a further configuration of the composite coating, the basecoat may have a fraction of greater than or equal to 1 wt. % of silicon and less than or equal to 10 wt. % of silicon. For the strength and weathering resistance of the composite coating, moreover, it has emerged as being particularly advantageous if the basecoat material has a fraction of silicon. This may, moreover, improve the adhesion of the coats to one another. This fraction of silicon originates preferably from compounds which form the topcoat and which diffuse into the basecoat material during production. As shown later, the fraction of silicon may be determined for example via SEM/EDX (in accordance with DIN EN ISO/IEC 17025:2018-03).

Further provided by the invention is a method for producing an at least 2-coat paint system composed of a lower basecoat and over it an upper topcoat on a substrate, the method having at least the following steps:

a) applying a basecoat comprising polymers selected from the group consisting of polyacrylates, polyurethanes, polyether polyols, polycarbonate polyols, polyester polyols, melamine resins, alkyd resins, or mixtures thereof on a substrate;

b) at least partly curing the basecoat;

c) applying a topcoat material to the basecoat at least partly cured in step b), the topcoat material comprising, as structuring component, silane group-containing prepolymers and/or crosslinking products thereof, the cured topcoat material having an Si content of greater than or equal to 2.0 and less than or equal to 9.0 wt. % and a catalyst content of greater than or equal to 0.01 wt. % and less than or equal to 5 wt. %, and the catalyst being selected from the group consisting of protic acids or Lewis acids, or mixtures thereof; and

d) at least partly curing the topcoat.

Surprisingly it has emerged that the method above is suitable for ensuring sufficient diffusion of the silane group-containing prepolymers from the topcoat into the basecoat. There is therefore improved adhesion between the two coats, possibly leading to improved mechanical properties on the part of the composite coating. As a result, for example, the mechanical properties can be improved, such as the elasticity of the composite or the weathering resistance. This is highly surprisingly, since silane group-containing prepolymers normally have strongly substrate-dependent property profiles and actually adhere poorly to basecoat materials as stated above. This contrasts with other substrates such as glass, for example, to which the silane group-containing prepolymers exhibit reasonable adhesion. By way of the method specified above, furthermore, it also appears that a gradient of silane group-containing prepolymers in the basecoat is produced, which in comparison to homogeneous mixing of the silane group-containing prepolymers into the formulation of the basecoat leads, structurally, to different results. Homogeneous mixing-in of the silane group-containing prepolymers as an additional component to the basecoat, accordingly, is not in accordance with the invention, and yields different composite coatings.

In the invention an at least 2-coat paint system is produced. The two-coat system of the invention may be used as the sole system, for modifying a substrate, or in combination with further coats. For example, it is possible, starting from the substrate, for there to be further coats as well as the basecoat. The further coats are in that case situated beneath the basecoat. A feature of the coat system of the invention, therefore, is a physical contact between the basecoat of the invention and the topcoat of the invention. Above the topcoat, moreover, there may also be further coats, which can be applied, independently of the topcoat of the invention, after the latter has cured. Also within the invention, therefore, is a sandwich made from the composite of the invention, having the combination of both coats inside.

The composite coating has at least one lower basecoat and an upper topcoat over it. This means that from the substrate side to the air side, the basecoat is situated closer to the substrate and the topcoat is situated closer to the air. The upper topcoat may be a clearcoat, meaning that the topcoat is transparent and the visual properties of the composite coating are determined via the visual properties of the basecoat.

The method comprises in step a) the applying of a basecoat comprising polymers selected from the group consisting of polyacrylates, polyurethanes, polyetherpolyols, polycarbonate polyols, polyester polyols, melamine resins, alkyd resins, or mixtures thereof to a substrate. The group of possible polymers has already been treated earlier on above in the discussion of the composite coatings of the invention. The applying of the polymers here may be accomplished by methods known to the skilled person, such as knifecoating, spreading, dipping or spraying, for example. The substrate may of course be pretreated previously by further steps, as for example by smoothing, roughening or cleaning of the surface.

In step b) the basecoat at least is partly cured. This curing may be accomplished purely physically, by removal of a solvent, or by reaction of the polymers with one another, to form structures of higher molecular weight. The basecoat material may be applied, for example, via the method below: the crosslinkable component of the above-described coating composition is mixed with the crosslinking component of the coating composition to form a pot mix or batch mix. In general, the crosslinkable component and the crosslinking component are mixed shortly before application to form a pot mix or a batch mix. The mixing may take place via a conventional mixing nozzle or separately in a container.

A coat of the pot mix or batch mix is applied generally with a thickness in the range from about 15 micrometers to about 20 micrometers to a substrate, such as an automotive body or an automotive body which has been precoated with an e-coating, followed by a primer. The preceding application step may be applied by spraying, electrostatic spraying, commercially supplied robot spraying system, roll coating, dipping, flooding or brushing of the pot mix or batch mix over the substrate. The coat is left to evaporate after application, hence being exposed to the air, in order to lower the solvent content of the pot mix or batch mix coat, to produce a “strike-in”-resistant or mixing-resistant coat. The time of the evaporation step is situated in ranges from about 5 to about 15 minutes. Then a coat of a clearcoat composition can be applied with a thickness in the range from about 15 micrometers to about 200 micrometers, by the means of application described earlier, over the “strike-in”-resistant or mixing-resistant coat, to form a multicoat system on the substrate.

In another variant, a coat of the pot mix or batch mix is applied in general with a thickness in the range from about 15 micrometers to about 200 micrometers to a substrate, such as an automotive body or an automotive body precoated with an e-coating followed by a primer, or precoated with a primer. The preceding application step may be applied by spraying, electrostatic spraying, commercially supplied robot spraying system, roll coating, dipping, flooding or brushing of the pot mix or batch mix over the substrate. The coat is left to evaporate after application, hence being exposed to the air, in order to lower the solvent content of the pot mix or batch mix coat, to produce a “strike-in”-resistant coat. The time of the evaporation step is situated in ranges from about 5 to about 15 minutes.

In step c), a topcoat material is applied to the basecoat at least partly cured in step b), where the topcoat material comprises, as structuring component, silane group-containing prepolymers and/or crosslinking products thereof, where the cured topcoat material has an Si content of greater than or equal to 2.0 and less than or equal to 9.0 wt. % and a catalyst content of greater than or equal to 0.01 wt. % and less than or equal to 5 wt. %, and where the catalyst is selected from the group consisting of protic acids or Lewis acids, or mixtures thereof. The topcoat may be applied here by the same methods as for the basecoat. The coat thickness of the topcoat here may be in the range from about 15 micrometers to about 200 micrometers. The silane group-containing prepolymers which can be used, and the group of suitable catalysts which can be used, have been described earlier on above. Determining the amount for the catalysts may be accomplished, for example, via an HPLC on the dissolved coat. The silicon content may be determined by elemental analysis, using ED-RFX, for example. The silicon content in the topcoat may preferably also be 3- 8 wt. %. This amount may lead to very weathering-resistant composite coatings.

In step d) the topcoat is at least partly cured. The curing of the topcoat here may be accomplished via purely physical removal of the solvents or through a chemical reaction, crosslinking, of the silane group-containing prepolymers with one another. Within the reaction, the topcoat solidifies to form structures or assemblies of higher molecular weight.

With the method of the invention it is preferable that the silane group-containing prepolymers and/or crosslinking products thereof have at least one thiourethane unit and/or urethane unit in the molecule.

Within one preferred embodiment of the method, the basecoat material can be at least partly dried at a temperature of greater than or equal to 10° C. and less than or equal to 80° C. The curing or drying conditions of the basecoat also appear to have an influence on the possibilities for diffusion of the silane group-containing prepolymers of the topcoat. For sufficient diffusion, the temperature range indicated above for the basecoat has proven preferable, since these drying conditions appear to present less resistance to the inward diffusion than instances of drying in a higher temperature range. This may contribute preferably to the inward diffusion of a sufficient fraction of silane group-containing prepolymers.

In one preferred aspect of the method, the catalyst of the topcoat may have a Pka of greater than or equal to −14.0 and less than or equal to 6. In order to achieve particularly efficient diffusion within the composite paint system as a whole, acids have proven particularly suitable as catalysts, and here more particularly protic acids with the acid strength indicated above. The equilibrium and hence also the catalyst effect are established with sufficient rapidity, enabling efficient diffusion and producing very uniform topcoats.

In one preferred embodiment of the method, the silane group-containing prepolymers may have a number-average molecular weight, measured according to DIN EN ISO 55672-1:2016-03, of greater than or equal to 250 g/mol and less than or equal to 40 000 g/mol. This particular molecular weight range for the silane group-containing prepolymers may contribute to particularly efficient diffusion of the silane group-containing prepolymers into the underlying basecoat. In this way, particularly stable adhesion can be achieved between basecoat and topcoat. Preferably the molecular weight may also be greater than or equal to 500 g/mol and less than or equal to 30 000 g/mol, more preferably greater than or equal to 750 g/mol and less than or equal to 20 000 g/mol.

In a further embodiment of the method, the at least partial curing in step d) may take place in a temperature range of greater than or equal to 10° C. and less than or equal to 90° C. The rapidity of the drying process for the topcoat may point to a particular influence in relation to the sufficient diffusion of the silane group-containing prepolymers from the topcoat into the basecoat. It has been found that particularly favorable embodiments, with a high elasticity of the composite coating, come about when the drying of the topcoat is carried out at relatively moderate temperatures. This may, furthermore, favorably influence the weathering resistance of the composite coating.

Also part of the invention is the use of the method of the invention for bonding, sealing or coating a substrate, and also the use of the composite coating of the invention for bonding, sealing or coating a substrate. Regarding the advantages of the use according to the invention, reference is made explicitly to the advantages of the method of the invention and to the advantages of the composite coating of the invention.

A further part of the invention is a vehicle or a vehicle bodywork part bearing a composite coating of the invention. The vehicle or the vehicle bodywork part may be composed of one or more materials. Suitable materials are, for example, metal, plastic or mixtures thereof. The vehicle may be any vehicle known to those skilled in the art. For example, the vehicle may be a motor vehicle, heavy goods vehicle, motorcycle, moped, bicycle or the like. The composite coating of the invention is especially suitable in the area of the manufacture of automotive coatings, since here, particularly, the elastic properties and an improved weathering resistance are sought-after qualities. Moreover, through the high optical transparency of the topcoat, the perceived color of a basecoat can be obtained to particularly good effect. Preferably, the vehicle is a motor vehicle and/or heavy goods vehicle (HGV), particularly preferably a motor vehicle.

### EXAMPLES

All reported percentages are based on weight unless otherwise stated.

All experiments were conducted unless otherwise indicated at 23° C. and 50% relative humidity. NCO contents were determined titrimetrically in accordance with DIN EN ISO 11909:2007-05.

OH numbers were determined by titrimetry according to DIN 53240-2: 2007-11, acid numbers according to DIN EN ISO 2114:2002-06. The OH contents reported were calculated from the OH numbers determined by analysis. The reported values in each case relate to the total weight of the respective composition including any solvent also used.

The residual monomer contents were measured according to DIN EN ISO 10283:2007-11 by gas chromatography with an internal standard.

The solids content was determined according to DIN EN ISO 3251:2008-06.

The viscosity was ascertained at 23° C. according to DIN EN ISO 3219/A:1994-10.

König pendulum damping was determined in accordance with DIN EN ISO 1522:2007-04 on glass plates. The STP films described were drawn down onto the glass plates using a bar coater. The dry film thickness was 35-40 μm for all films.

Solvent and water resistances were ascertained to DIN EN ISO 4628-1:2016-07. The solvent resistances test was carried out using the solvents xylene (also abbreviated hereinafter to “Xy”), methoxypropyl acetate (also abbreviated hereinafter to “MPA”), ethyl acetate (also abbreviated hereinafter to “EA”), and acetone (also abbreviated hereinafter to “Ac”). The contact time was 5 min in each case. For the measurement of the water resistances, the contact time was 24 h in each case.

Rating took place in line with the recited standard. The test surface is assessed visually and by scratching, using the following classification: 0=no change apparent; 1=swelling ring, hard surface, only visible change; 2=swelling ring, slight softening; 3=distinct softening (possibly slight blistering); 4=significant softening (possibly severe blistering), can be scratched through to the substrate; 5=coating completely destroyed without outside influence.

The interface between the STP coat and the basecoat was determined using SEM/EDX in accordance with DIN EN ISO/IEC 17025:2018-03.

Materials used

Vestanat EP-M 95 was obtained from Evonik AG, Essen, and used without further purification or modification.

The diisocyanates used are products of Covestro Deutschland AG, Leverkusen, Germany. Dibutyltin dilaurate (DBTL) was obtained from TIB Chemicals, Mannheim, Germany.

Stabaxol I was used from Lanxess AG, Rhein Chemie, Mannheim, Germany.

Basecoat material (black) Spies Hecker Permahyd Basecoat 280 super tief schwarz. Dilution with DI water (95%). Baking conditions: 80° C., 10 min or around 30 min air drying.

Basecoat (white) Spies Hecker, Mischlack 280 WB 801, weiB. This basecoat can be used for determining the Delta-Lab values.

All other commercially available chemicals were obtained from Sigma-Aldrich, Taufkirchen, Germany.

Polymeric polyols A)

Polymeric polyol A1) 70% solution in butyl acetate of polyacrylate polyol prepared from 6.3% ethyl acrylate, 0.7% acrylic acid, 17.6% isobornyl acrylate, 21.1% hydroxyethyl methacrylate, 7% methyl methacrylate and 14.3% styrene. OH content: 2.4-2.7%; acid number: 7±1 mg; viscosity (23° C.): 1200±200 mPas; solid content: 70.0%±2.0%.

### Example 1

### Preparation of isocyanatosilane 1

1340 g (8 mol) of HDI were admixed under dry nitrogen at a temperature of 70° C. with 1240 g (1 mol) (3-mercaptopropyl)triethoxysilane and, after addition of 0.25 g (2.04 mmol) of DABCO, the mixture was stirred for 2 h until an NCO content of 39.3%, corresponding to full conversion, had been attained. Subsequently, the unconverted monomeric HDI was removed on a thin-film evaporator at a temperature of 140° C. and a pressure of 0.1 mbar. This gave a virtually colorless, clear isocyanatosilane having the following characteristics: NCO content: 9.8%; viscosity (23° C.): 60 mPas.

### Example 2

### Isocyanatosilane 2

2220 g (10 mol) of isophorone diisocyanate (IPDI) were admixed under dry nitrogen at a temperature of 80° C. with 196 g (1.0 mol) of mercaptopropyltrimethoxysilane and, after addition of 0.06 g (25 ppm) of dibutyltin dilaurate (DBTL), the mixture was stirred for 3 hours until an NCO content of 33.0%, corresponding to a full conversion, had been attained. Subsequently, the unconverted monomeric IPDI was removed on a thin-film evaporator at a temperature of 150° C. and a pressure of 0.1 mbar. This gave a virtually colorless, clear isocyanatosilane having the following characteristics: NCO content=9.7%; solids fraction=100%; viscosity (23° C.)=5400 mPas.

### Example 3

### Preparation of STP-1

765 g of the isocyanatosilane prepared in example 1 and 8.9 g (0.06 mol) of tetraethyl orthoformate (TEOF) were admixed under dry nitrogen at 80° C. with 128 g (0.9 mol) of 2-ethyl-1,3-hexanediol and 0.02 g (0.03 mmol) of dibutyltin(IV) dilaurate (DBTL) and the reaction was conducted until a residual NCO of 0.3% was attained. The crude product was admixed with 100 g of butylacetate (BuAc). This gave a virtually colorless, clear STP-1 having a number-average molecular weight Mn of 942 g/mol and the following characteristics: Residual NCO content: 0.3%; viscosity (23° C.) 280 mPas; solids content: 80%.

### Example 4

### Preparation of STP-2

506 g of the isocyanatosilane prepared according to example 1, 15 g (0.1 mol) of TEOF and 10 drops of DBTL were charged to a reactor and heated to 80° C. Then a mixture of 728 g of polyol Al and 36.9 g (0.1 mol) of Stabaxol I was added. The reaction mixture was stirred at 80° C. for 5 h. The product was lastly admixed with 214 g of BuAc and used without further purification. This gave a virtually colorless, clear STP-3 having a number-average molecular weight Mn of 1740 g/mol and the following characteristics: Residual NCO content: <0.24%; viscosity (23° C.): 490 mPas; solids content: 70%.

### Example 5

### Preparation of STP-3

540.1 g of example 2, 4.59 g of tetraethyl orthoformate (TEOF) and one drop of DBTL are admixed under dry nitrogen at 80° C. with 89.2 g of 2-ethyl-1,3-hexanediol. After 5 h, a further drop of DBTL is added and the reaction is stirred until a residual NCO of <0.3% is attained. The crude product is admixed with 127.0 g of butyl acetate (BuAc). This gives a virtually colorless silane having the following characteristics: Residual NCO content=<0.3%; viscosity (23° C.)=9000 mPas; solids content=80%.

Basecoat Formulation

In order to detect the migration of silane-terminated prepolymers into the basecoat material, an aqueous basecoat, black, based on a secondary acrylate (OH-containing) was prepared. For this purpose, the components were weighed out successively, mixed and, as specified in the formulation, dispersed with a dissolver having a dispersing disk.

| | Amount |
|---|---|
| Basecoat 1 | (g) |
| I.) Bayhydrol A 2542, as-supplied form. | 34.81 |
| Distilled water | 25.25 |
| Dimethylethanolamine, 10% in dist. | 6.02 |
| water (for pH 8-8.5) | |
| 2-Ethyl-1-hexanol | 2.79 |
| BYK 347, as-supplied form. | 0.17 |
| BYK 345, as-supplied form. | 0.17 |
| BYK 011, as-supplied form. | 1.45 |
| Byketol AQ, as-supplied form. | 2.76 |
| Solus 3050, 20% in butyl glycol/ | 2.61 |
| dist. water/DMEA (50.00/28.58/1.42) | |
| Rheovis AS 1130, as-supplied form. | 1.75 |
| n-Butanol | 0.14 |
| -disperse at about 10.5 m/s for 5 min.- | |
| II.) Pigment paste, black, consisting of: | 6.20 |
| Setaqua B E 270, as-supplied form. | 10.40 |
| dist. water | 41.60 |
| Borchi Gen 0851, as-supplied form. | 32.00 |
| Colour Black FW 200 | 16.00 |
| -disperse at about 10.5 m/s for 30 min.- | |
| III.) Dist. water | 15.88 |
| Total weight | 100.00 |

This produces a solids content at spray viscosity of 21.7%, a flow time in the DIN cup, (4 mm) of 30 s, and a pH of around 8.3.

Topcoat Formulations

The amount of the flow control agent added was calculated based on the solid resin content. The amount of catalyst was calculated based on the solid resin content. The topcoats were produced by initially introducing the binders and then adding, with stirring, the solvent and subsequently in mandated order the additives at room temperature with continued stirring. The solvent was butyl acetate. The amounts of solvent were chosen such that the solids contents were the same. The topcoats were produced freshly immediately prior to application.

| | Clearcoat 1 | Clearcoat 2 | Clearcoat 3 |
|---|---|---|---|
| STP-1 | 100.00 | | |
| Vestanat EP-M 95 | | 100.00 | |
| STP-2 | | | 100.00 |
| Butyl acetate (BA) | 48.63 | 74.86 | 22.40 |
| BYK 331, 10% in BA | 0.85 | 1.00 | 0.70 |
| Nacure 4000, 10% in BA | 6.38 | 7.50 | 5.25 |
| Total weight | 155.86 | 183.36 | 128.35 |
| Solids content (theo.), wt %. | 55.0 | 55.0 | 55.0 |
| Catalyst, solid based on | 0.75 | 0.75 | 0.75 |
| resin solids | | | |

Migration Experiments

For the migration experiments, the basecoat was drawn down onto a polypropylene (PP) plate by means of 50 μm spiral-wound coating bar, flashed off at room temperature for 5 minutes and then dried in an air circulation paint drying cabinet at 80° C. for 20 min Immediately after being cooled down (20 min RT), the clearcoat under test was then applied to the basecoat by means of a spiral-wound coating bar (formulation 1=100 μm, formulation 4=150 μm, formulation 6=110 μm), flashed off at room temperature for 5 minutes, and then baked in an air circulation paint drying cabinet at 100° C. for 30 min. The film thicknesses of basecoat (around 12 μm dry film) are identical in all of the experimental setups. The plates were then stored under standard conditions for 24 hours, and the paint system was peeled from the PP plate, and the basecoat was then analyzed on its underside by means of an FT-IR spectrometer (Tensor II with platinum ATR unit (diamond crystal) from Bruker). Single measurements were conducted. The spectra were evaluated by performing a Min-Max standardization in the 3900-3800 cm-1 range; no baseline correction was performed.

The signals indicated below were evaluated as characteristic bands for the silane-terminated prepolymers and also for the basecoat. These signals are employed in order to describe the diffusion of the STP topcoat into the basecoat:

| | |
|---|---|
| 3323/3304 cm⁻¹ | signal height |
| 1685/1651 cm⁻¹ | signal height |
| 1590-1485 cm⁻¹ | integration over absorption region |

Evaluation of the Migration Experiments

The FT-IR spectra of the water-based basecoat, of the STP clearcoat and of the multicoat system based on these two components were compared. Surprisingly it was observed here that there is migration of the STP topcoat into the basecoat. This was found on the basis of the IR spectral evaluation and demonstrated by various experiments. In addition, the diffusion was characterized quantitatively by means of energy-dispersive X-ray spectroscopy (SEM/EDX) (see end of section). For this purpose, firstly, the signal heights of the absorption maxima of the STP clearcoat were compared with the corresponding absorption intensities of the water-based basecoat. Secondly, integration took place over an absorption region of the multicoat system−basecoat+STP clearcoat −and the area obtained was compared with that of an aqueous basecoat without clearcoat.

The table below presents the absorption maxima for various coatings and coating systems. The migration of the STP clearcoat into the basecoat is described here, illustratively, on the basis of STP-1. In order to be able to detect migration, an absorption maximum of the clearcoat 1 (STP 1) was employed that exhibits an intense absorption band in comparison to the basecoat with the corresponding wavenumber; for clearcoat 1 (STP 1), 3304 cm⁻¹ was chosen.

| | | Absorption | Absorption | Difference | Percent |
|---|---|---|---|---|---|
| | | maximum | maximum | relative to | (ratio: |
| | | at 3304 | at 3323 | basecoat | Clearcoat X/ |
| No. | System | cm⁻¹ (a.u.) | cm⁻¹ (a.u) | (a.u.) | basecoat 1) |
| 1 | Basecoat 1 | 46.4 | 48.2 | . | |
| 2 | Clearcoat 1^{[1]} | 217.5 | — | . | |
| | (Topcoat) | | | | |
| 3 | Clearcoat 1^{[1]} + | 110.0 | — | 64 | 237% |
| | Basecoat 1 | | | | |
| 4 | Clearcoat 2^{[2]} | — | 259.6 | — | — |
| | (Topcoat) | | | | |
| 5 | Clearcoat 2^{[2]} + | — | 201.6 | 153 | 418% |
| | Base coat 1 | | | | |
| 6 | Clearcoat 3^{[3]} | — | 178.8 | — | — |
| | (Topcoat) | | | | |
| 7 | Clearcoat 3^{[3]} + | — | 49.0 | 1 | 102% |
| | Basecoat 1 | | | | |

^{[1]}STP 1; ^{[2]}Vestanat EP-M 95; ^{[3]}STP-2.

The absorption maxima (FT-IR) of a water-based basecoat, of an STP topcoat and of a multicoat system consisting of basecoat and STP topcoat were investigated in the range between 3304 cm⁻¹ and 3323 cm⁻¹. For evaluation, to start with, determinations were made of the intensity (a.u) of the IR absorption band of STP 1 (No. 2) and of the basecoat (No. 1) at 3304 cm⁻¹. Subsequently an IR spectrum of the multicoat system (No. 3)—Basecoat with STP 1—was recorded. In these IR investigations it was found that characteristic bands of the STP are repeated in the reverse-side IR spectrum of the basecoat. This will be discussed using, as an example, clearcoat 1, based on STP-1: for the basecoat, identified here as basecoat 1 (No. 1), a signal with an intensity of 46.4 a.u. was measured at a wavenumber of 3304 cm⁻¹. The multicoat system (No. 3), in contrast, showed a much more intense signal, at 110.0 a.u.; this corresponds to an intensity difference of 237%. This intense absorption band was found beforehand with a stronger intensity for the pure clearcoat 1 (No. 2). On this basis, the diffusion of the clearcoat 1 into the basecoat is verified.

The table below shows the absorption maxima (FT-IR) of a water-based basecoat, of an STP topcoat and a multicoat system composed of basecoat and STP, in the region between 1651 cm⁻¹ and 1685 cm⁻¹.

| | | Absorption | Absorptions | Difference | |
|---|---|---|---|---|---|
| | | maximum | maximum | relative to | |
| | | At 1651 | at 1685 | the basecoat | |
| No. | System | cm⁻¹ (a.u.) | cm⁻¹ (a.u) | (a.u.) | Percent |
| 1 | Basecoat 1 | 75.9 | 167.0 | — | — |
| 2 | Clearcoat 1^{[1]} | 600.5 | — | — | — |
| | (Topcoat) | | | | |
| 3 | Clearcoat 1^{[1]} + | 376.2 | — | 300 | 496% |
| | Basecoat 1 | | | | |
| 4 | Clearcoat 2^{[2]} | — | 911.2 | — | |
| | (Topcoat) | | | | |
| 5 | Clearcoat 2^{[2]} + | — | 821.6 | 655 | 492% |
| | Basecoat 1 | | | | |
| 6 | Clearcoat 3^{[3]} | 610.8 | — | — | |
| | (Topcoat) | | | | |
| 7 | Clearcoat 3^{[3]} + | 158.0 | — | 82 | 208% |
| | Basecoat | | | | |

^{[1]}STP 1; ^{[2]}Vestanat EP-M 95; ^{[3]}STP-2.

From the table it is apparent that analogous results were obtained for the absorption maxima of the clearcoats at 1651 cm⁻¹ and 1685 cm⁻¹. The results are discussed using, as an example, the case of STP 2. At 1651 cm⁻¹, an intensity of 75.9 a.u. was observed for the basecoat (No. 1). For the clearcoat 3 (No. 6), an intensity of 610.8 a.u. was found. In the multicoat system (No. 7)—basecoat and clearcoat 3—an intensity of 158.0 (a.u.) was measured. The latter corresponds to an increase in the basecoat signal (No. 1) by 208%. The increased signal intensity at a wavenumber of 1651 cm⁻¹ is attributed to clearcoat 3, since at the wavenumber stated, this clearcoat exhibits a very strong absorption band, which is reflected here partly in the clearcoat 1—basecoat system. These results demonstrate that there is diffusion of the clearcoat 3 into the basecoat.

As well as the signal height, i.e., the intensity, it is also possible to employ the area under the absorption bands for characterizing the diffusion of the STP clearcoats through a basecoat. One such is discussed, illustratively, by using the example of the STP Vestanat EP-M 95 (table, see below). This is a chemically modified STP which has only one urethane group and no supplementary thiourethane group. In the absorption region from 1590 cm⁻¹ to 1485 cm⁻¹ (see above), the area under the absorption band was determined at 8394 (a.u.) for basecoat 1 (No. 1). The area of the STP (No. 6) is 39 908 (a.u.). For the multicoat system (No. 7), the area is found to be 33 013 (a.u.). This corresponds to an increase of 393%. This figure is close to the figure for the integral area of the STP clearcoat (No. 6).

| | | Integrated | Difference | |
|---|---|---|---|---|
| | | area in the | relative to | |
| | Absorption region | absorption | the | % age |
| No. | (1590-1485 cm⁻¹) | region (a.u.) | basecoat | difference |
| 1 | Basecoat 1 | 8394 | — | — |
| 2 | STP 1 (clearcoat) | 33745 | — | — |
| 3 | STP 1 + Basecoat 1 | 20890 | 12496 | 248% |
| 4 | STP 2 (clearcoat) | 33561 | — | |
| 5 | STP 2 + basecoat 1 | 9603 | 1209 | 114% |
| 6 | Vestanat EP-M 95 | 39908 | — | — |
| | (clearcoat) | | | |
| 7 | Vestanat EP-M 95 + | 33013 | 24619 | 393% |
| | Basecoat 1 | | | |

These experiments show that there is diffusion through the basecoat irrespective of the structure and molecular weight of the STP. For this, both the signal intensity and the area of the signal were used.

This diffusion can be correlated very well with the mechanical properties of the composite coatings. Without being tied to the theory, preferred mechanical properties and, in particular, especially good adhesion of the composite coating result from the diffusion of the STP into the basecoat.

Measurements by means of energy-dispersive X-ray spectroscopy (SEM/EDX) confirmed the surprising findings with phosphorus-containing catalysts. This method can also be used to determine the extent of the diffusion by means of the characteristic elements from the coating materials. In this case, the coatings not only are studied with the surprisingly suitable phosphorus-containing acid catalysts, but also are compared with sulfur-containing acid catalyst systems. The latter likewise exhibit diffusion into the clearcoat, this being desirable to the skilled person for known technical reasons.

The following examples use a physical mixture of different STPs in order to describe the diffusion of the clearcoat into the basecoat. The measurements show that there is diffusion of the clearcoat into the basecoat of at least 5 gm. This surprising finding shows that in combination with the stated catalyst systems, the STP coating promotes adhesion between the coats and the crosslinking of the basecoat.

| | Clearcoat 4 | Clearcoat 5 |
|---|---|---|
| Component | (g) | (g) |
| STP-1 | 56.00 | 56.00 |
| STP-2 | 21.00 | 21.00 |
| STP-3 | 8.00 | 8.00 |
| Dibutyl phosphate/diphenyl | 0.99/3.30 | — |
| phosphate (10% in BA) | | |
| H₂SO₄ (10% in MeOH) | — | 3.30 |
| BYK 315N (10% in MPA) | 1.98 | 1.98 |
| MPA | (41.53) | (41.53) |

For the sulfur content and silicon content, which each originate from the clearcoat, 7.5% and 6%, respectively, were found in the EDX measurements. From the boundary layer up to 15 μm within the basecoat, a decrease in the sulfur content from 6.5% to 1.5% is found; for silicon, a decrease from 4.5% to 1.0% is found (clearcoat 4).

| No. | Coating system | Clearcoat 4 | Clearcoat 5 |
|---|---|---|---|
| | Sulfur content | 7.5% | 7.0% |
| | (Clearcoat) | | |
| | Sulfur content | 6.5%/4.0%/2.5%/1.5% | 6.0%/2.0%/0%/0% |
| | (basecoat, black) | | |
| | (0 μm*/5 μm/10 | | |
| | μm/15 μm) | | |
| | Silicon content | 6% | 6% |
| | (clearcoat) | | |
| | Silicon content | 4.5%/3.0%/2.0%/1.0% | 5.0%/1.5%/0%/0% |
| | (basecoat, black) | | |
| | (0 μm*/5 μm/10 | | |
| | μm/15 μm) | | |
| | Carbon content | 65% | 64% |
| | (clearcoat) | | |
| | Carbon content | 70%/74%/77%/79% | 66%/75%/78%/78% |
| | (basecoat, black) | | |
| | (0 μm*/5 μm/10 | | |
| | μm/15 μm) | | |

*Interface between clearcoat and basecoat (black)

With sulfur-containing catalysts such as sulfuric acid, a lower diffusion is observed for the STP coating (clearcoat 5); the diffusion limit thereof is reached above 6 μm.

1. A composite coating comprising a lower basecoat arranged over a topcoat on a substrate,
wherein
the basecoat material comprises greater than or equal to 50 wt. % and less than 100 wt. % of polymers selected from the group consisting of polyacrylates, polyurethanes, polyether polyols, polycarbonate polyols, polyester polyols, melamine resins, alkyd resins, and mixtures thereof;
the topcoat comprises greater than or equal to 40 wt. % and less than or equal to 100 wt. % of a compound selected from the group consisting of silane group-containing prepolymers and/or crosslinking products thereof; and
the basecoat material comprises greater than or equal to 0.5 wt. % and less than or equal to 15 wt. % of a compound selected from the group consisting of silane group-containing prepolymers and/or crosslinking products thereof;
and wherein the silane group-containing prepolymers and crosslinking products thereof have at least one of a thiourethane unit and a urethane unit in the molecule.

2. The composite coating as claimed in claim 1, wherein the silane group-containing prepolymers or their crosslinking products are selected from the group consisting of polyurethanes, polymeric polyisocyanates, reaction products of polymeric polyols with silane-containing compounds, polyether polyols, polyester polyols, polycarbonate polyols, polyacrylate polyols, polymethacrylate polyols, polyurea, polyurethane polyols, and mixtures thereof, and wherein individual prepolymers of this group each have at least one alkoxysilane group.

3. The composite coating as claimed in claim 1, wherein the silane group-containing prepolymers or crosslinking products thereof are selected from the group consisting of low molecular alcohols, polyacrylate polyols, polyester polyols, polysiloxane polyols, and mixtures thereof.

4. The composite coating as claimed claim 1, wherein the topcoat comprises a catalyst selected from the group consisting of phosphoric acid, dibutyl phosphate, bis(ethylhexyl phosphate), diphenyl phosphate, dimethyl phosphate, methyl phosphate, trimethyl phosphate, phenylphosphonic acid, phenylphosphinic acid, and mixtures thereof in a concentration of greater than or equal to 0.25 wt. % and less than or equal to 2.5 wt. %, based on the weight of the topcoat.

5. The composite coating as claimed in claim 1, wherein the upper topcoat at a layer thickness of 50 μm on a white basecoat has a delta-Lab value in relation to white basecoat of ΔL greater than or equal to 0.2 and less than or equal to 20, of Δa greater than or equal to −0.01 and less than or equal to −20, and Δb greater than or equal to −0.01 and less than or equal to −13, determined in accordance with DIN EN ISO 1166-4:2012-06.

6. The composite coating as claimed in claim 1, wherein the composite coating has a pendulum hardness, measured to DIN EN ISO 1522:2000-09, of greater than or equal to 60 s and less than or equal to 180 s.

7. The composite coating as claimed in claim 1, wherein the basecoat has a silicon fraction of greater than or equal to 1 wt. % and less than or equal to 10 wt. %.

8. A method for producing an at least 2-coat paint system comprising a lower basecoat and arranged an upper topcoat on a substrate,
wherein
the method comprises at least the following steps:
a) applying a basecoat comprising polymers selected from the group consisting of polyacrylates, polyurethanes, polyether polyols, polycarbonate polyols, polyester polyols, melamine resins, alkyd resins, and mixtures thereof on a substrate;
b) at least partly curing the basecoat;
c) applying a topcoat material to the basecoat at least partly cured in step b), the topcoat material comprising, as structuring component, at least one of silane group-containing prepolymers and crosslinking products thereof, the cured topcoat material having an Si content of greater than or equal to 2.0 and less than or equal to 9.0 wt. % and a catalyst content of greater than or equal to 0.01 wt. % and less than or equal to 5 wt. %, and the catalyst being selected from the group consisting of protic acids, Lewis acids, and mixtures thereof; and
d) at least partly curing the topcoat.

9. The method as claimed in claim 8, wherein the silane group-containing prepolymers or the crosslinking products thereof have at least one of a thiourethane unit and/or a urethane unit in the molecule.

10. The method as claimed in claim 8, wherein the basecoat material is at least partly dried at a temperature of greater than or equal to 10° C. and less than or equal to 80° C.

11. The method as claimed in claim 8, wherein the catalyst of the topcoat has a pKa of greater than or equal to −14.0 and less than or equal to 6.

12. The method as claimed in claim 8, wherein the silane group-containing prepolymers have a number-average molecular weight, measured according to DIN EN ISO 55672-1:2016-03, of greater than or equal to 250 g/mol and less than or equal to 40 000 g/mol.

13. The method as claimed in claim 8, wherein the at least partial curing in step d) takes place in a temperature range of greater than or equal to 10° C. and less than or equal to 90° C.

14. A method of bonding, sealing or coating a substrate, wherein the method includes the composite coating as claimed in claim 1.

15. A vehicle or vehicle bodywork part having a composite coating as claimed in claim 1.
